(19) United States
(12) Patent Application Publication
(10) Pub. No.: US 2026/0313709 A1
(43) Pub. Date: Oct. 8, 2026

(54) ADAPTIVE AND LAYERED MASKING FOR PHYSICAL RANDOM ACCESS CHANNEL RESOURCES

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 19/640,006

(22) Filed: Apr. 6, 2026

Related U.S. Application Data
(60) Provisional application No. 63/785,470, filed on Apr. 8, 2025.

(51) Int. Cl. H04W 74/0833; H04L 5/00

(52) U.S. Cl. CPC H04W 74/0833; H04L 5/0053

(57) ABSTRACT

Various aspects of the present disclosure generally relate to wireless communication. In some aspects, a user equipment (UE) may receive configuration information that indicates a physical random access channel (PRACH) mask index, wherein a granularity of the PRACH mask index is determined based at least in part on whether a condition is satisfied. The UE may transmit a PRACH communication via a set of PRACH resources, wherein the set of PRACH resources are determined based at least in part on the granularity of the PRACH mask index. Numerous other aspects are described.

### CROSS-REFERENCE TO RELATED APPLICATION

This Patent Application claims priority to U.S. Provisional Patent Application No. 63/785,470, filed on Apr. 8, 2025, entitled “ADAPTIVE AND LAYERED MASKING FOR PHYSICAL RANDOM ACCESS CHANNEL RESOURCES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with adaptive and layered masking for physical random access channel resources.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In wireless communication systems, a physical random access channel may be used for network access procedures. For example, a user equipment may perform a random access procedure to establish a wireless communication connection to a network.

### SUMMARY

Some aspects described herein relate to a method of wireless communication performed by a user equipment (UE). The method may include receiving configuration information that indicates a physical random access channel (PRACH) mask index, wherein a granularity of the PRACH mask index is determined based at least in part on whether a condition is satisfied. The method may include transmitting a PRACH communication via a set of PRACH resources, wherein the set of PRACH resources are determined based at least in part on the granularity of the PRACH mask index.

Some aspects described herein relate to a method of wireless communication performed by a UE. The method may include receiving configuration information indicating two or more PRACH mask indexes. The method may include transmitting a PRACH communication via a set of resources, wherein the set of resources are determined based at least in part on a superposition of two or more PRACH masks associated with the two or more PRACH mask indexes.

Some aspects described herein relate to a method of wireless communication performed by a network node. The method may include transmitting configuration information that indicates a PRACH mask index, wherein a granularity of the PRACH mask index is determined based at least in part on whether a condition is satisfied. The method may include receiving a PRACH communication via a set of PRACH resources, wherein the set of PRACH resources are determined based at least in part on the granularity of the PRACH mask index.

Some aspects described herein relate to a method of wireless communication performed by a network node. The method may include transmitting configuration information indicating two or more PRACH mask indexes. The method may include receiving a PRACH communication via a set of resources, wherein the set of resources are determined based at least in part on a superposition of two or more PRACH masks associated with the two or more PRACH mask indexes.

Some aspects described herein relate to a non-transitory computer-readable medium that stores a set of instructions for wireless communication by a UE. The set of instructions, when executed by one or more processors of the UE, may cause the UE to receive configuration information that indicates a PRACH mask index, wherein a granularity of the PRACH mask index is determined based at least in part on whether a condition is satisfied. The set of instructions, when executed by one or more processors of the UE, may cause the UE to transmit a PRACH communication via a set of PRACH resources, wherein the set of PRACH resources are determined based at least in part on the granularity of the PRACH mask index.

Some aspects described herein relate to a non-transitory computer-readable medium that stores a set of instructions for wireless communication by a UE. The set of instructions, when executed by one or more processors of a UE, may cause the UE to receive configuration information indicating two or more PRACH mask indexes. The set of instructions, when executed by one or more processors of the UE, may cause the UE to transmit a PRACH communication via a set of resources, wherein the set of resources are determined based at least in part on a superposition of two or more PRACH masks associated with the two or more PRACH mask indexes.

Some aspects described herein relate to a non-transitory computer-readable medium that stores a set of instructions for wireless communication by a network node. The set of instructions, when executed by one or more processors of the network node, may cause the network node to transmit configuration information that indicates a PRACH mask index, wherein a granularity of the PRACH mask index is determined based at least in part on whether a condition is satisfied. The set of instructions, when executed by one or more processors of the network node, may cause the network node to receive a PRACH communication via a set of PRACH resources, wherein the set of PRACH resources are determined based at least in part on the granularity of the PRACH mask index.

Some aspects described herein relate to a non-transitory computer-readable medium that stores a set of instructions for wireless communication by a network node. The set of instructions, when executed by one or more processors of the network node, may cause the network node to transmit configuration information indicating two or more PRACH mask indexes. The set of instructions, when executed by one or more processors of the network node, may cause the network node to receive a PRACH communication via a set of resources, wherein the set of resources are determined based at least in part on a superposition of two or more PRACH masks associated with the two or more PRACH mask indexes.

Some aspects described herein relate to a UE. The UE may include one or more antennas and a processing system. The processing system may include one or more processors and one or more memories that store code and are coupled with the one or more processors. The processing system may be configured to cause the UE to wirelessly receive, from a network node, configuration information that indicates a PRACH mask index, wherein a granularity of the PRACH mask index is determined based at least in part on whether a condition is satisfied. The processing system may be configured to cause the UE to wirelessly transmit, to the network node, a PRACH communication via a set of PRACH resources, wherein the set of PRACH resources are determined based at least in part on the granularity of the PRACH mask index.

Some aspects described herein relate to a UE. The UE may include one or more antennas and a processing system. The processing system may include one or more processors and one or more memories that store code and are coupled with the one or more processors. The processing system may be configured to cause the UE to wirelessly receive, from a network node, configuration information indicating two or more PRACH mask indexes. The processing system may be configured to cause the UE to wirelessly transmit, to the network node, a PRACH communication via a set of resources, wherein the set of resources are determined based at least in part on a superposition of two or more PRACH masks associated with the two or more PRACH mask indexes.

Some aspects described herein relate to a network node. The network node may include a plurality of antennas and a processing system. The processing system may include one or more processors and one or more memories that store code and are coupled with the one or more processors. The processing system may be configured to cause the network node to wirelessly transmit, to a UE, configuration information that indicates a PRACH mask index, wherein a granularity of the PRACH mask index is determined based at least in part on whether a condition is satisfied. The processing system may be configured to cause the network node to wirelessly receive, from the UE, a PRACH communication via a set of PRACH resources, wherein the set of PRACH resources are determined based at least in part on the granularity of the PRACH mask index.

Some aspects described herein relate to a network node. The network node may include a plurality of antennas and a processing system. The processing system may include one or more processors and one or more memories that store code and are coupled with the one or more processors. The processing system may be configured to cause the network node to wirelessly transmit, to a UE, configuration information indicating two or more PRACH mask indexes. The processing system may be configured to cause the network node to wirelessly receive, from the UE, a PRACH communication via a set of resources, wherein the set of resources are determined based at least in part on a superposition of two or more PRACH masks associated with the two or more PRACH mask indexes.

Some aspects described herein relate to an apparatus for wireless communication. The apparatus may include means for receiving configuration information that indicates a PRACH mask index, wherein a granularity of the PRACH mask index is determined based at least in part on whether a condition is satisfied. The apparatus may include means for transmitting a PRACH communication via a set of PRACH resources, wherein the set of PRACH resources are determined based at least in part on the granularity of the PRACH mask index.

Some aspects described herein relate to an apparatus for wireless communication. The apparatus may include means for receiving configuration information indicating two or more PRACH mask indexes. The apparatus may include means for transmitting a PRACH communication via a set of resources, wherein the set of resources are determined based at least in part on a superposition of two or more PRACH masks associated with the two or more PRACH mask indexes.

Some aspects described herein relate to an apparatus for wireless communication. The apparatus may include means for transmitting configuration information that indicates a PRACH mask index, wherein a granularity of the PRACH mask index is determined based at least in part on whether a condition is satisfied. The apparatus may include means for receiving a PRACH communication via a set of PRACH resources, wherein the set of PRACH resources are determined based at least in part on the granularity of the PRACH mask index.

Some aspects described herein relate to an apparatus for wireless communication. The apparatus may include means for transmitting configuration information indicating two or more PRACH mask indexes. The apparatus may include means for receiving a PRACH communication via a set of resources, wherein the set of resources are determined based at least in part on a superposition of two or more PRACH masks associated with the two or more PRACH mask indexes.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example of a two-step random access procedure.

FIG. 3 is a diagram illustrating an example of a four-step random access procedure.

FIG. 4 is a diagram illustrating an example of random access channel occasion groups.

FIG. 5 is a diagram of an example associated with adaptive and layered masking for physical random access channel (PRACH) resources.

FIGS. 6A-6D are diagrams of examples associated with utilizing a reference table to determine a granularity of a PRACH mask.

FIG. 7 is a diagram of an example associated with utilizing multiple PRACH masks for masking for PRACH resources.

FIG. 8 is a diagram illustrating an example process performed, for example, at a user equipment (UE) or an apparatus of a UE.

FIG. 9 is a diagram illustrating an example process performed, for example, at a UE or an apparatus of a UE.

FIG. 10 is a diagram illustrating an example process performed, for example, at a network node or an apparatus of a network node.

FIG. 11 is a diagram illustrating an example process performed, for example, at a network node or an apparatus of a network node.

FIG. 12 is a diagram illustrating an example process performed, for example, at a UE or an apparatus of a UE.

FIG. 13 is a diagram illustrating an example process performed, for example, at a network node or an apparatus of a network node.

FIG. 14 is a diagram of an example apparatus for wireless communication.

FIG. 15 is a diagram of an example apparatus for wireless communication.

### DETAILED DESCRIPTION

In wireless communication systems, a physical random access channel (PRACH) may be used for network access procedures. For example, a user equipment (UE) may perform a random access procedure to establish a wireless communication connection to a network. In some cases, the random access procedure may begin with the UE transmitting a PRACH communication that includes a PRACH preamble. The UE may transmit the PRACH communication in a PRACH resource.

In some cases, prior to the UE transmitting the PRACH communication, a network node may transmit (e.g., broadcast) configuration information indicating a PRACH configuration. In some cases, the PRACH configuration may indicate PRACH resources that the UE can use to transmit the PRACH communication. In some cases, the PRACH configuration may be used to accommodate varying network load conditions and implement efficient network-energy-saving (NES) strategies.

In some cases, to implement NES, the PRACH configuration may be used to dynamically adapt PRACH resources in the time domain. For example, a network node may transmit an initial PRACH configuration with sparsely allocated PRACH occasions to allow network components, such as network nodes, to enter low power or sleep states during periods of inactivity. As used herein, “occasion” refers to one or more resources (e.g., time domain resources, frequency domain resources, spatial domain resources, code domain resources, or other resources) that are available for, or configured for, the communication (e.g., the transmission or the reception) of a communication or message (e.g., a PRACH occasion may be one or more resources available for, or configured for, the communication of a PRACH communication).

To adapt to fluctuating network demands, additional PRACH occasions can be configured to be available dynamically. For example, these additional PRACH occasions may be subject to a masking mechanism that determines the availability of the additional PRACH occasions over time to enable a network node to dynamically adapt the quantity of available PRACH occasions based at least in part on a quantity of access requests and an NES strategy being implemented by the network node.

In some aspects, the masking mechanism may be implemented using a PRACH mask index. For example, the PRACH mask index may define one or more PRACH occasions (e.g., time and frequency resources) that a UE is allowed to use to initiate a random access procedure. For example, the UE may be configured with a table that defines a mapping between various PRACH indexes and PRACH masking patterns (e.g., a PRACH masking pattern masking all PRACH occasions, every even PRACH occasion, every odd PRACH occasion, every fourth PRACH occasion, every PRACH occasion in a first half of a system frame, or every PRACH occasion in a second half of a system frame, among other examples).

Generally, mapping synchronization signal blocks (SSBs) to PRACH resources is needed in order to allow a wireless communication device (e.g., a UE or a network node) to indicate an SSB preferred by the wireless communication device. For example, a given SSB may correspond to a particular beam. Thus, by transmitting a PRACH communication in particular PRACH resources that map to a preferred SSB, the wireless communication device indicates a beam to the network node (e.g., such that the network node can transmit a random access response using the indicated beam). In some examples, the mapping pattern associated with mapping SSBs to PRACH resources (referred to herein as an “association pattern”) may repeat with an identifiable period (referred to herein as an “association pattern period”) to enable the wireless communication device to determine which SSBs are associated with particular PRACH resources.

In some examples, the mapping pattern may repeat after an association period. In some examples, the association period may be equal to an association pattern period multiplied by an integer number (e.g., a value that identifies a quantity of association pattern periods). In some examples, the association period may be equal to a minimum value, of a set of values, that satisfies a full mapping for transmitted SSBs. For example, if an association pattern period is 10 milliseconds (ms) and the set of possible values includes 1, 2, 4, 8, and 16, the association pattern mapping (e.g., the SSB to PRACH resource mapping pattern) may repeat after every 10 ms (e.g., 10 ms×1=10 ms), every 20 ms (e.g., 10 ms×2=20 ms), every 40 ms (e.g., 10 ms×4=40 ms), every 80 ms (e.g., 10 ms×8=80 ms), or every 160 ms (e.g., 10 ms×16=160 ms).

In some examples, the repetition period for the association pattern may be selected as the minimum of these five durations that allows a full set of SSBs to be mapped to respective PRACH resources. For example, if the network node transmits 32 SSBs, and 9 PRACH resources are configured within a given 10 ms association pattern period, 9 PRACH resources are configured within 10 ms (e.g., one association pattern period), 18 PRACH resources are configured within 20 ms (e.g., two association pattern periods), and 36 PRACH resources are configured within 40 ms (e.g., four association pattern periods). As a result, a full SSB to PRACH resource mapping requires at least four association pattern periods, indicating that the mapping pattern should repeat after every 40 ms. Hence, the association period in this case is 40 ms.

The granularity of the masking mechanism (e.g., the PRACH mask) can be applied at the level of association periods or association pattern periods. However, if the masking mechanism is applied at the association pattern level and there is only one association pattern in the association period, masking cannot be effectively realized. Furthermore, the choice of granularity in defining the masking mechanism, whether at the association period level or the association pattern period level, may impact the network's energy-saving potential and its ability to capture small-scale variations in access demand.

Various aspects relate generally to adaptive and layered masking for PRACH resources. Some aspects more specifically relate to a UE receiving configuration information indicating a PRACH mask index, where the granularity of the PRACH mask index is determined based on whether certain conditions are satisfied, and transmitting a PRACH communication via a set of PRACH resources determined by this granularity. In some aspects, the granularity may vary based on a reference period type, which is determined by the conditions met in the configuration.

In some aspects, the configuration information may indicate two or more PRACH mask indexes. A granularity of a first PRACH mask indicated by a first PRACH mask index may be at the association period level and a granularity of a second PRACH mask associated with a second PRACH mask index may be at the association pattern period level. In some aspects, a set of resources (e.g., random access channel (RACH) occasions) may be determined based at least in part on a superposition of the first and second masks. The technique of superimposing two or more PRACH masks allows for a more sophisticated strategy in PRACH resource availability control. This approach permits the network to achieve lower energy states and reduce operational costs by minimizing energy usage during periods of low demand, while maintaining the ability to handle access requests without significant delays.

Particular aspects of the subject matter described in this disclosure can be implemented to realize technical advantages. By enabling the granularity of the PRACH mask index to dynamically adapt based on network conditions and configurations, the described techniques can optimize network resource allocation, resulting in reduced energy consumption. This optimization can facilitate more efficient use of PRACH resources, allowing the network to precisely manage its active and sleep states, which conserves energy and enhances network performance.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

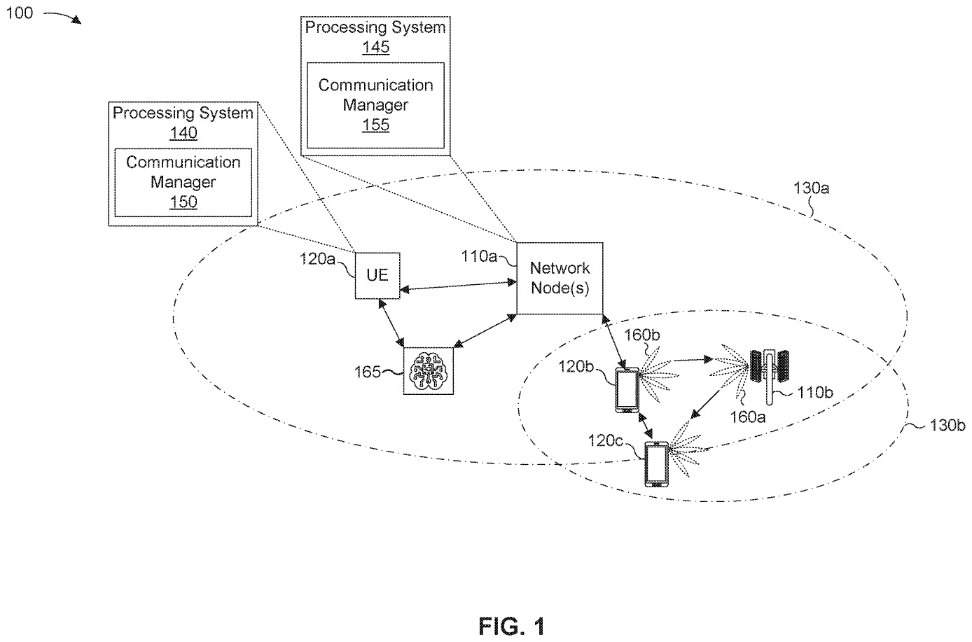

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

NES or network energy efficiency measures are expected to have increased importance in wireless network operations for various reasons, such as climate change mitigation, environmental sustainability, or network cost reduction, among other examples. For example, although NR generally offers a significant energy efficiency improvement per gigabyte over previous generations (for example, LTE), new NR use cases or the adoption of millimeter wave frequencies may require more network sites, more network antennas, larger bandwidths, or more frequency bands, among other examples which may lead to more efficient wireless networks that nonetheless have higher energy requirements or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption or energy costs are associated with a RAN, which accounts for about half of the energy consumption in a wireless network, with data centers and fiber transport accounting for smaller shares. Accordingly, measures to increase network energy savings or improve network energy efficiency are factors that may drive adoption or expansion of wireless networks.

In some examples, a UE 120 or network node 110 may implement power saving features (also referred to as energy saving features). Power saving features may include, for example, relaxed radio resource monitoring (such as relaxed reference signal monitoring for devices operating in low mobility or in good radio conditions), discontinuous reception (DRX) operation, reduced PDCCH monitoring during DRX active times, on-demand system information transmission, on-demand SSB transmission, antenna port adaptation, advanced CSI reporting, or power-efficient paging reception.

In some aspects, a UE 120 may include a communication manager 150. As described in more detail elsewhere herein, the communication manager 150 may receive configuration information that indicates a PRACH mask index, wherein a granularity of the PRACH mask index is determined based at least in part on whether a condition is satisfied; and transmit a PRACH communication via a set of PRACH resources, wherein the set of PRACH resources are determined based at least in part on the granularity of the PRACH mask index. Additionally, or alternatively, the communication manager 150 may perform one or more other operations described herein.

In some aspects, a UE 120 may include a communication manager 150. As described in more detail elsewhere herein, the communication manager 150 may receive configuration information indicating two or more PRACH mask indexes; and transmit a PRACH communication via a set of resources, wherein the set of resources are determined based at least in part on a superposition of two or more PRACH masks associated with the two or more PRACH mask indexes. Additionally, or alternatively, the communication manager 150 may perform one or more other operations described herein.

In some aspects, a network node 110 may include a communication manager 155. As described in more detail elsewhere herein, the communication manager 155 may transmit configuration information that indicates a PRACH mask index, wherein a granularity of the PRACH mask index is determined based at least in part on whether a condition is satisfied; and receive a PRACH communication via a set of PRACH resources, wherein the set of PRACH resources are determined based at least in part on the granularity of the PRACH mask index. Additionally, or alternatively, the communication manager 155 may perform one or more other operations described herein.

In some aspects, a network node 110 may include a communication manager 155. As described in more detail elsewhere herein, the communication manager 155 may transmit configuration information indicating two or more PRACH mask indexes; and receive a PRACH communication via a set of resources, wherein the set of resources are determined based at least in part on a superposition of two or more PRACH masks associated with the two or more PRACH mask indexes. Additionally, or alternatively, the communication manager 155 may perform one or more other operations described herein.

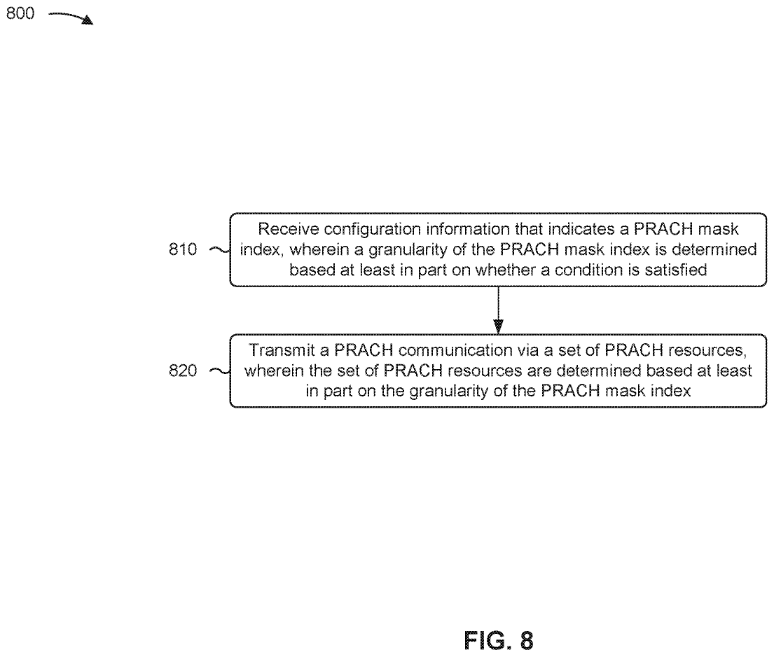

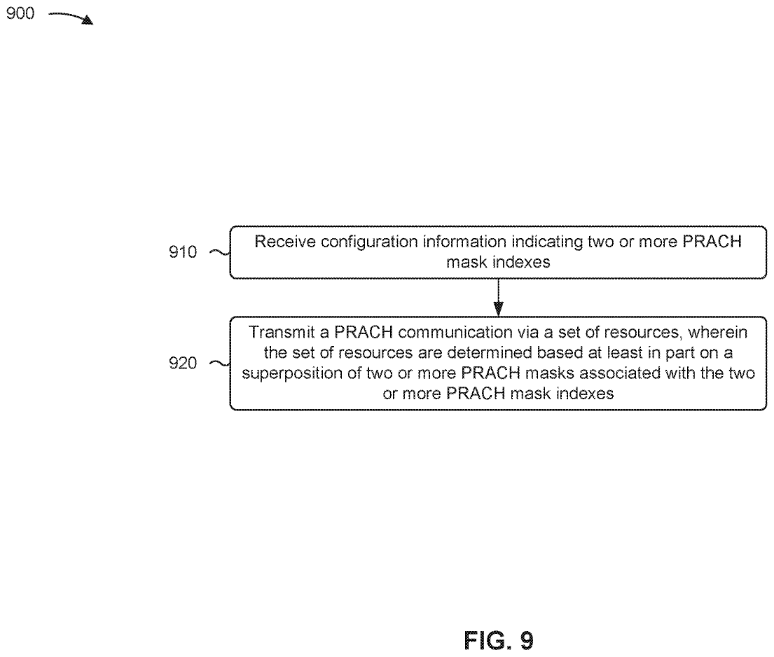

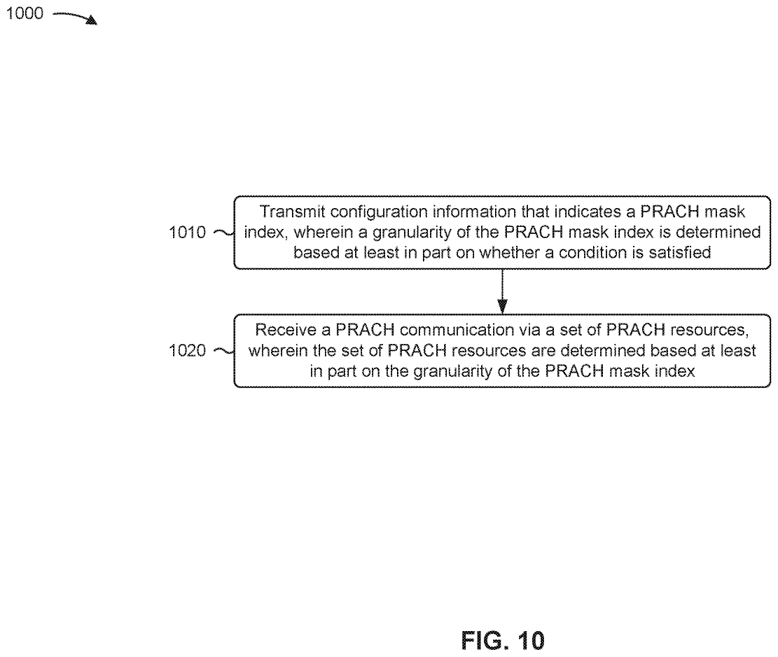

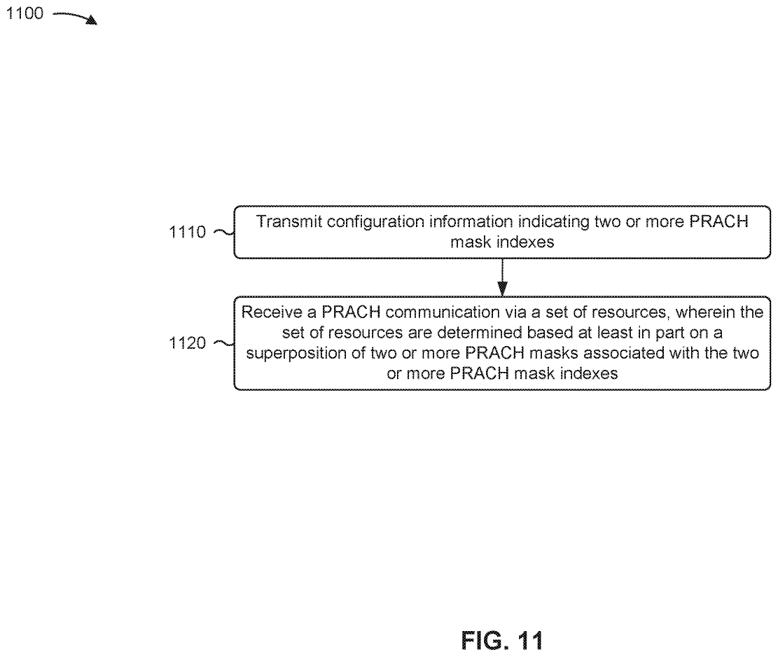

The network node 110, the processing system 145 of the network node 110, the UE 120, the processing system 140 of the UE 120, or any other component(s) of FIG. 1 may implement one or more techniques or perform one or more operations associated with adaptive and layered masking for PRACH resources, as described in more detail elsewhere herein. For example, the processing system 145 of the network node 110, or the processing system 140 of the UE 120 may perform or direct operations of, for example, process 800 of FIG. 8, process 900 of FIG. 9, process 1000 of FIG. 10, process 1100 of FIG. 11, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 800 of FIG. 8, process 900 of FIG. 9, process 1000 of FIG. 10, process 1100 of FIG. 11, or other processes as described herein. In some examples, executing instructions may include running the instructions, converting the instructions, compiling the instructions, or interpreting the instructions, among other examples.

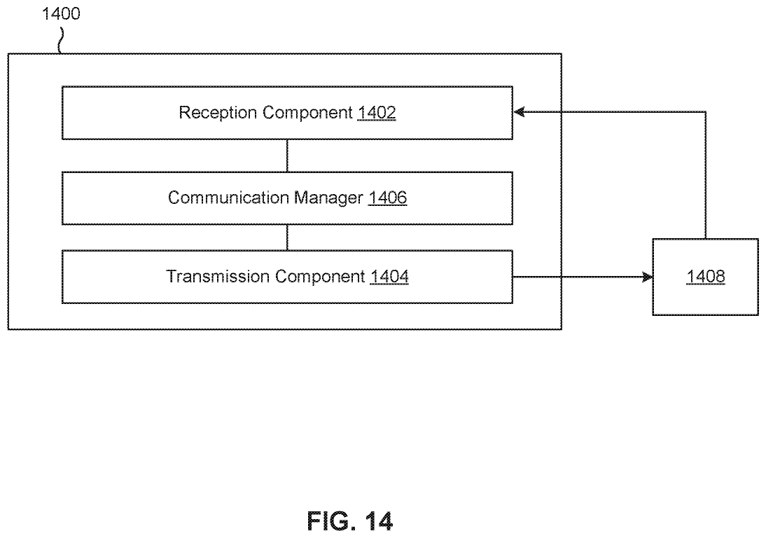

In some aspects, a UE includes means for receiving configuration information that indicates a PRACH mask index, wherein a granularity of the PRACH mask index is determined based at least in part on whether a condition is satisfied; or means for transmitting a PRACH communication via a set of PRACH resources, wherein the set of PRACH resources are determined based at least in part on the granularity of the PRACH mask index. The means for the UE to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

In some aspects, a UE includes means for receiving configuration information indicating two or more PRACH mask indexes; or means for transmitting a PRACH communication via a set of resources, wherein the set of resources are determined based at least in part on a superposition of two or more PRACH masks associated with the two or more PRACH mask indexes. The means for the UE to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

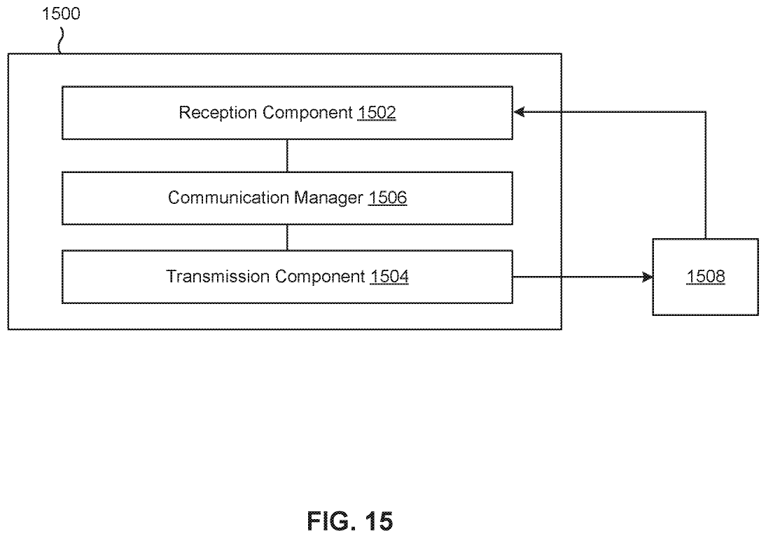

In some aspects, a network node includes means for transmitting configuration information that indicates a PRACH mask index, wherein a granularity of the PRACH mask index is determined based at least in part on whether a condition is satisfied; or means for receiving a PRACH communication via a set of PRACH resources, wherein the set of PRACH resources are determined based at least in part on the granularity of the PRACH mask index. The means for the network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

In some aspects, a network node includes means for transmitting configuration information indicating two or more PRACH mask indexes; or means for receiving a PRACH communication via a set of resources, wherein the set of resources are determined based at least in part on a superposition of two or more PRACH masks associated with the two or more PRACH mask indexes. The means for the network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

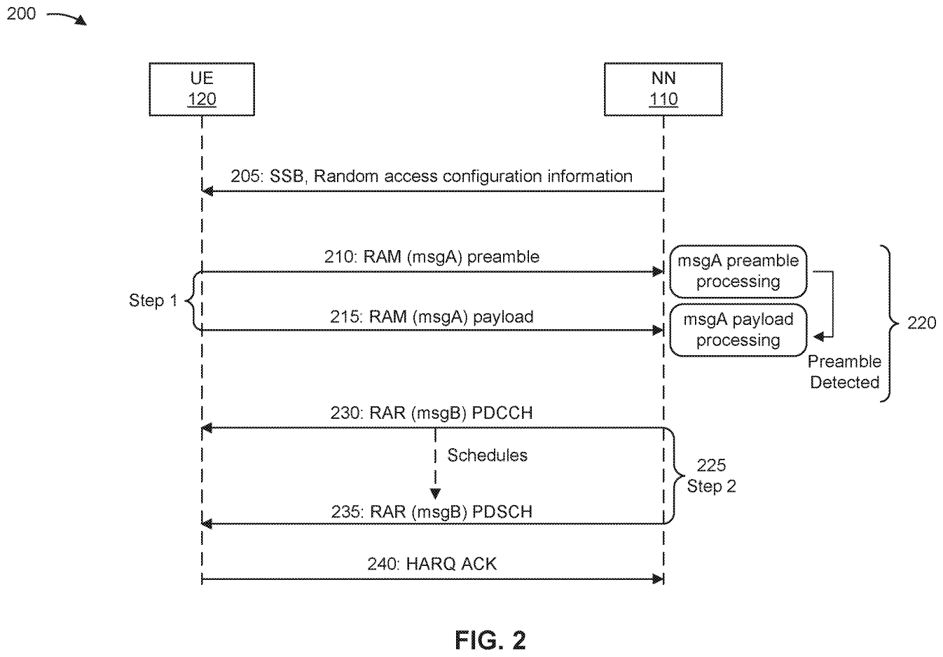

FIG. 2 is a diagram illustrating an example 200 of a two-step random access procedure. As shown in FIG. 2, a network node 110 and a UE 120 may communicate with one another to perform the two-step random access procedure.

As shown by reference number 205, the network node 110 may transmit, and the UE 120 may receive, one or more SSBs and random access configuration information. In some examples, the random access configuration information may be transmitted in or indicated by system information (e.g., in one or more system information blocks (SIBs)) or an SSB, such as for contention-based random access. Additionally, or alternatively, the random access configuration information may be transmitted in an RRC message or a PDCCH order message that triggers a RACH procedure, such as for contention-free random access (CFRA). The random access configuration information may include one or more parameters to be used in the two-step random access procedure, such as one or more parameters for transmitting a random access message (RAM) or receiving a random access response (RAR) to the RAM.

As shown by reference number 210, the UE 120 may transmit, and the network node 110 may receive, a RAM preamble. As shown by reference number 215, the UE 120 may transmit, and the network node 110 may receive, a RAM payload. As shown, the UE 120 may transmit the RAM preamble and the RAM payload to the network node 110 as part of an initial (or first) step of the two-step random access procedure. In some examples, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, uplink control information (UCI), or a PUSCH transmission).

As shown by reference number 220, the network node 110 may receive the RAM preamble transmitted by the UE 120. If the network node 110 successfully receives and decodes the RAM preamble, the network node 110 may then receive and decode the RAM payload.

As shown by reference number 225, the network node 110 may transmit an RAR (sometimes referred to as an RAR message). As shown, the network node 110 may transmit the RAR message as part of a second step of the two-step random access procedure. In some examples, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, or contention resolution information.

As shown by reference number 230, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 235, as part of the second step of the two-step random access procedure, the network node 110 may transmit the PDSCH communication for the RAR, as scheduled by the PDCCH communication. The RAR may be included in a MAC protocol data unit (PDU) of the PDSCH communication. As shown by reference number 240, if the UE 120 successfully receives the RAR, the UE 120 may transmit a HARQ ACK.

As indicated above, FIG. 2 is provided as an example. Other examples may differ from what is described with regard to FIG. 2.

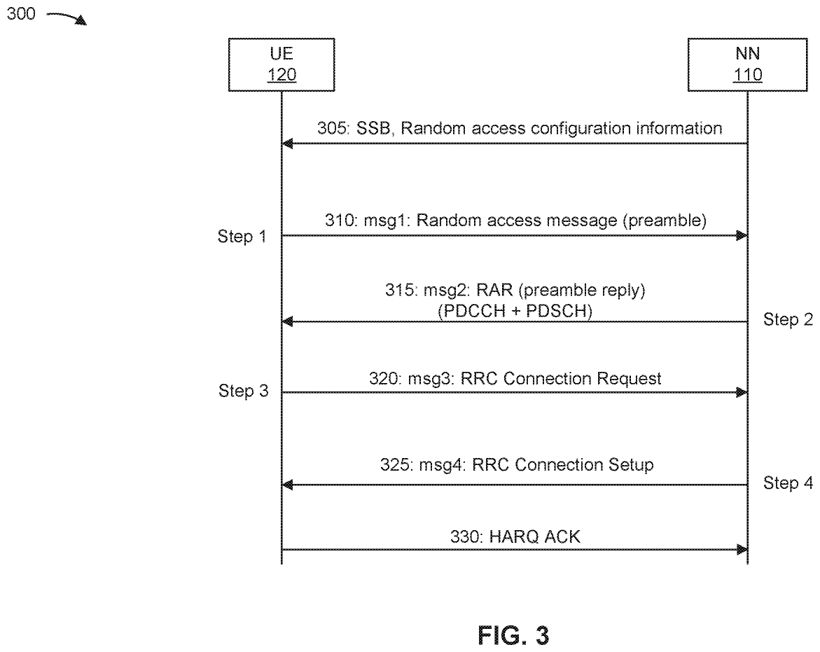

FIG. 3 is a diagram illustrating an example of a four-step random access procedure. As shown in FIG. 3, a network node 110 and a UE 120 may communicate with one another to perform the four-step random access procedure.

As shown by reference number 305, the network node 110 may transmit, and the UE 120 may receive, one or more SSBs and random access configuration information. In some aspects, the random access configuration information may be transmitted in or indicated by system information (e.g., in one or more SIBs) or an SSB, such as for contention-based random access (CBRA). Additionally, or alternatively, the random access configuration information may be transmitted in an RRC message or a PDCCH order message that triggers a RACH procedure, such as for CFRA. The random access configuration information may include one or more parameters to be used in the random access procedure, such as one or more parameters for transmitting a RAM or one or more parameters for receiving an RAR.

As shown by reference number 310, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 315, the network node 110 may transmit an RAR as a reply to the preamble. The message that includes the RAR may be referred to as message 2, msg2, MSG2, or a second message in a four-step random access procedure. In some examples, the RAR may indicate the detected random access preamble identifier (e.g., received from the UE 120 in msg1). Additionally, or alternatively, the RAR may indicate a resource allocation to be used by the UE 120 to transmit a message 3 (msg3).

In some examples, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 320, the UE 120 may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 325, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 330, if the UE 120 successfully receives the RRC connection setup message, the UE 120 may transmit a HARQ ACK.

As indicated above, FIG. 3 is provided as an example. Other examples may differ from what is described with regard to FIG. 3.

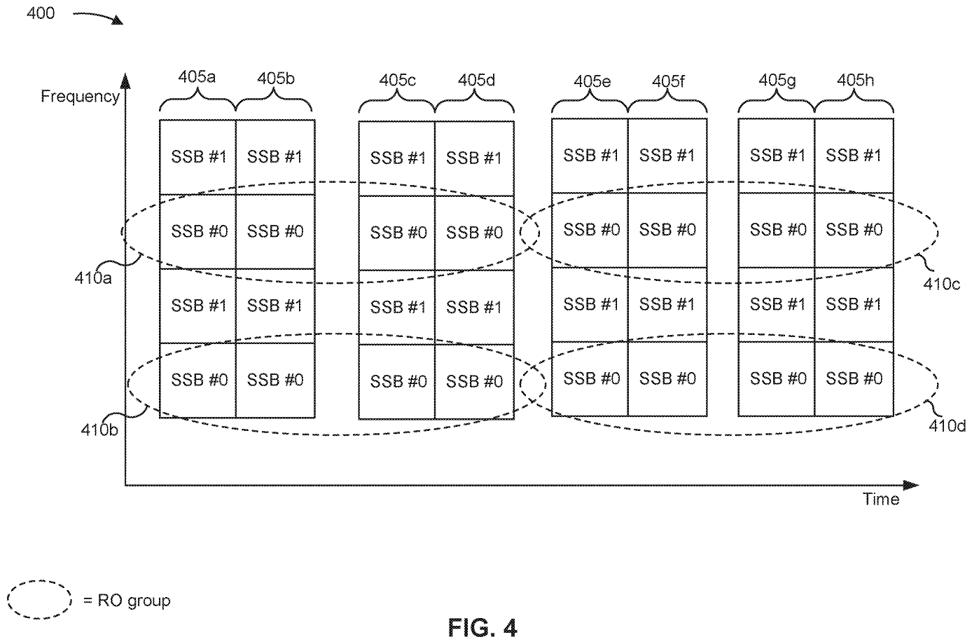

FIG. 4 is a diagram illustrating an example 400 of RACH occasion groups.

As shown in FIG. 4, multiple RACH occasion (RO) groups may be defined in a frequency domain and in a time domain. An RO may also be referred to herein as a RACH occasion, a PRACH occasion, or a random access transmission opportunity. An RO group may be associated with a periodic pattern. The RO group may include a first starting RO. The RO group may be a set of

$${N}_{preamble}^{rep}$$

valid ROs, or PRACH occasions, that are consecutive in time and use the same frequency resources. When a number of repetitions for a random access (RA) message (e.g., as indicated by an

$${N}_{preamble}^{rep}$$

parameter) is four PRACH repetitions, two SSBs (e.g., SSB #0 and SSB #1) may be used as shown in FIG. 4 as an example. Each RO may have four frequency division multiplexed ROs (across RO groups), and an RO group may have four valid ROs. For other numbers of repetitions (e.g., two, eight, or another number), a different number of SSBs may be used and/or each RO group may include a different number of ROs.

For example, as shown in FIG. 4, a network node 110 may configure SSB indices to be associated with respective time domain occasions 405 (shown in FIG. 4 as time domain occasions 405a, 405b, 405c, 405d, 405e, 405f, 405g, and 405h). The time domain occasion 405 and a frequency domain occasion associated with a given SSB index may be configured as an RO. As shown in FIG. 4, one or more RO groups 410 may be formed. In the example shown in FIG. 4, each RO group 410 (e.g., RO group 410a, RO group 410b, RO group 410c, and RO group 410d) may include two or more ROs (e.g., four ROs as shown in FIG. 4). An RO group may also be referred to as a set of valid ROs. When a UE 120 transmits repetitions of an RA message, such as a Msg1, the UE 120 may transmit the repetitions via respective ROs included in a given RO group 410. This enables the network node 110 to identify the ROs in which repetitions of a given RA message are to be transmitted by the UE 120, thereby enabling the network node 110 to efficiently and accurately combine the repetitions of the RA message for improved performance of the RA message (e.g., improved likelihood of correct decoding and/or detection of the RA message).

In some examples, the UE 120 may determine the RO groups 410 based on configuration information received from the network node 110. For example, ROs may be mapped consecutively per corresponding SSB index. The UE 120 may determine the SSB-RO mapping based on identifying valid ROs. The UE 120 may determine whether an RO is valid. For example, from a physical layer perspective at a UE 120, a four-step RACH procedure, also known as a Type-1 random access procedure, includes transmission of a random access preamble (Msg1) in a valid RO (sometimes called a PRACH occasion), reception of a random access response (RAR) message with a PDCCH/PDSCH (Msg2), and when applicable, transmission of a PUSCH scheduled by an uplink grant in the RAR (Msg3) and reception of a PDSCH for contention resolution (Msg4).

Additionally, or alternatively, in a two-step RACH procedure, also known as a Type-2 random access procedure, a UE 120 transmits a random access preamble in a valid RO and transmits a PUSCH payload (collectively referred to as MsgA) and the UE 120 then receives a RAR message with a PDCCH/PDSCH (MsgB). Furthermore, when applicable, the UE 120 transmits a PUSCH scheduled by a fallback uplink grant in the RAR and receives a PDSCH for contention resolution. In either case, when a RACH procedure is triggered (e.g., by higher layers at the UE 120 or by a PDCCH order message received from a network node 110), the UE 120 may determine an RO (e.g., corresponding to time and frequency resources for a PRACH transmission) in which to transmit the random access preamble, also known as a PRACH, according to an SSB-RO mapping.

For example, prior to initiation of a RACH procedure or transmission of a PRACH, a network node 110 may provide a UE 120 with random access configuration information that indicates PRACH transmission parameters (e.g., a PRACH preamble format, time/frequency resources for PRACH transmission, a preamble index, or a preamble SCS, among other examples). Furthermore, the UE 120 may receive an indication of one or more SSB indexes in an ssb-PositionsInBurst parameter (e.g., indicated in a SIB type 1 (SIB1) and/or a ServingCellConfigCommon parameter) that are mapped to valid ROs. For example, the SSB indexes indicated in the ssb-PositionsInBurst parameter are mapped to valid ROs in an increasing order of preamble indexes within a single RO, then in an increasing order of frequency resource indexes for frequency multiplexed ROs, then in an increasing order of time resource indexes for time multiplexed ROs within a PRACH slot, and then in an increasing order of indexes for PRACH slots. In this way, when a PRACH transmission is triggered at the UE 120, the UE 120 may transmit a PRACH preamble in a valid RO that is mapped to an SSB index (e.g., an SSB index indicated in a PDCCH order triggering the PRACH transmission or an SSB index selected by the UE 120). Accordingly, because the UE 120 transmits the PRACH preamble in a valid RO that is mapped to or otherwise associated with an SSB index, the UE 120 may apply one or more validation rules to determine whether an RO is valid or invalid. For example, in paired spectrum or a supplementary uplink band, all ROs are valid. However, for unpaired spectrum (e.g., a time division duplexing (TDD) band), an RO must satisfy one or more validation rules to be considered valid.

For example, the validation rules that are applied to determine whether an RO is valid or invalid may depend on whether a UE 120 has been provided with a parameter that indicates an uplink and downlink TDD configuration, or TDD pattern. For example, the uplink and downlink TDD configuration may be indicated in a tdd-UL-DL-ConfigurationCommon parameter, and may include a periodicity of a TDD pattern, a number of consecutive full downlink slots that begin each TDD pattern, a number of consecutive downlink symbols in the beginning of a slot that follows a last full downlink slot, a number of consecutive full uplink slots that end each TDD pattern, and a number of consecutive uplink symbols in the end of a slot that precedes a first full uplink slot. Accordingly, as described herein, the UE 120 may apply a first set of validation rules to determine whether an RO is valid in cases where the uplink and downlink TDD configuration has not been provided, and may apply a second set of validation rules to determine whether an RO is valid in cases where the uplink and downlink TDD configuration has been provided.

For example, if the UE 120 has not been provided with an uplink and downlink TDD configuration, an RO in a PRACH slot is valid if the RO does not precede an SSB in the PRACH slot and starts at least N_{gap} symbols after a last SSB reception symbol, where N_{gap} may have a value that depends on a preamble SCS (e.g., N_{gap} may have a value of 0 for a preamble SCS of 1.25 kilohertz (kHz) or 5 kHz, 2 for a preamble SCS of 15 kHz, 30 kHz, 60 kHz, or 120 kHz, 8 for a preamble SCS of 480 kHz, or 16 for a preamble SCS of 960 kHz). Furthermore, in cases where a semi-static channel access mode is configured, a valid RO cannot overlap with a set of consecutive symbols before the start of a next channel occupancy time where the UE 120 does not transmit. Otherwise, an RO that fails to satisfy the applicable validation rules is considered invalid for SSB-RO mapping purposes and for PRACH transmission. For example, an RO may be invalid because the RO precedes an SSB in the PRACH slot. Furthermore, an RO may be invalid because the RO is fewer than N_{gap} symbols after a last SSB reception symbol. On the other hand, an RO that does not precede an SSB in a PRACH slot and is at least N_{gap} symbols after a last SSB reception symbol is considered valid.

Additionally, or alternatively, if the UE 120 has been provided with an uplink and downlink TDD configuration, an RO is valid if the RO is within uplink symbols. For example, an RO may be valid because the RO is within uplink symbols. Alternatively, if an RO is not within uplink symbols (e.g., is within downlink or flexible symbols), then the RO is valid only if the RO does not precede an SSB in a PRACH slot and starts at least N_{gap} symbols after a last downlink symbol and least N_{gap} symbols after a last SSB symbol, where N_{gap} may have a value that depends on a preamble SCS. Furthermore, in cases where a semi-static channel access mode is configured, a valid RO cannot overlap with a set of consecutive symbols before the start of a next channel occupancy time where no transmissions are permitted. Otherwise, an RO that fails to satisfy the applicable validation rules is considered invalid for SSB-RO mapping purposes and for PRACH transmission. For example, an RO may be invalid because the RO precedes an SSB in the PRACH slot. Furthermore, an RO may be invalid because the RO is fewer than N_{gap} symbols after a last downlink symbol and fewer than N_{gap} symbols after a last SSB symbol. On the other hand, an RO that does not precede an SSB in a PRACH slot and is at least N_{gap} symbols after a last downlink symbol and a last SSB reception symbol is considered valid.

The indexing of the PRACH occasion indicated by a mask index value may be reset per mapping cycle of consecutive PRACH occasions per SSB index. The UE 120 may select, for a transmission of an RA message (e.g., a PRACH transmission), an RO indicated by a PRACH mask index value for the indicated SSB index in the first available mapping cycle. For a given preamble index, the ordering of ROs may be: first, in increasing order of frequency resource indices for frequency multiplexed ROs; second, in increasing order of time resource indexes for time multiplexed ROs within a PRACH time interval (e.g., a PRACH slot); and third, in increasing order of indexes for PRACH slot.

For a PRACH transmission with

$${N}_{preamble}^{rep}$$

preamble repetitions, a set consists of

$${N}_{preamble}^{rep}$$

valid ROs that are consecutive in time, use same frequency resources, and are associated with same one or more SSB index(es). For example, if the

$${N}_{preamble}^{rep}$$

parameter indicates four repetitions, then the set of valid ROs may include four ROs. Each SSB index may be associated with same preamble indexes in all valid ROs within the set. The set of valid ROs may form an RO group 410.

For a transmission of an RA message (e.g., a PRACH transmission) with preamble repetitions, a time period, starting from a frame 0, may be the smallest integer number of association pattern periods such that at least one set of valid PRACH occasions for each of the SSB indices can be determined within the time period for all configured number of preamble repetitions. The set(s) of valid PRACH occasions for each configured number of preamble repetitions may repeat every time period.

Within a time period, for set(s) of

$${N}_{preamble}^{rep}$$

valid ROs for a PRACH transmission with

$${N}_{preamble}^{rep}$$

preamble repetitions (e.g., for a given RO group 410), the first valid RO of the first set may be the first valid RO. The first valid RO of subsequent sets, if any, may be determined according to an ordering of valid ROs: first, in increasing order of frequency resource indexes for frequency multiplexed ROs; second, in increasing order of time resource indexes for time multiplexed ROs. For each frequency resource index for frequency multiplexed ROs, the first valid RO of the first set is the first valid RO, and the first valid PRACH occasion of subsequent sets, if any, is: after a number of consecutive valid ROs (e.g., indicated by a msg1-RepetitionTimeOffsetROGroup parameter) in time from the first valid RO of the previous set, where each RO is associated with same SSB index(es) and SSB index is associated with same preambles, if the msg1-RepetitionTimeOffsetROGroup parameter is provided; or is after the ROs for the previous set, if the msg1-RepetitionTimeOffsetROGroup parameter is not provided.

As indicated above, FIG. 4 is provided as an example. Other examples may differ from what is described with respect to FIG. 4.

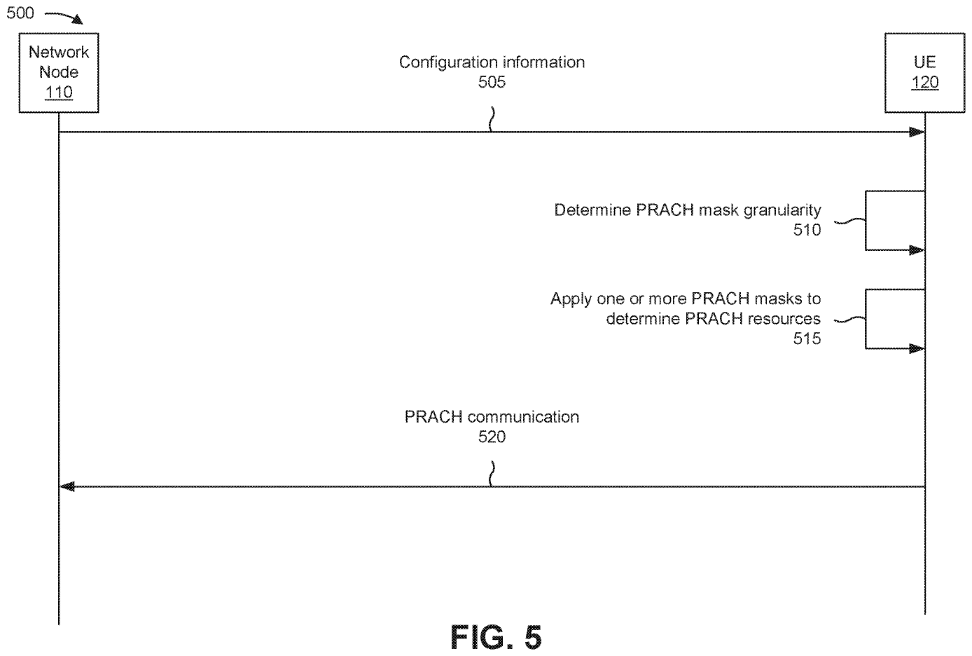

FIG. 5 is a diagram of an example 500 associated with adaptive and layered masking for PRACH resources. As shown in FIG. 5, a network node 110 may communicate with a UE 120. In some aspects, the network node 110 and the UE 120 may be part of a wireless communication network (e.g., wireless communication network 100).

As shown by FIG. 5, and reference number 505, the network node 110 may transmit, and the UE 120 may receive, configuration information. For example, the network node 110 may transmit the configuration information via system information, RRC signaling, or DCI messages. These various signaling methods may ensure flexibility and reliability in transmitting the configuration information to the UE.

In some aspects, the network node 110 may send the configuration information via broadcast signaling, dedicated signaling, or control channel messages. For example, broadcast signaling may include SIBs, while dedicated signaling may involve RRC signaling messages. Control channel messages may include DCI messages.

In some aspects, the configuration information may include random access configuration information, as described in connection with FIGS. 2 and 3. In some aspects, the configuration information may indicate one or more PRACH resources and one or more additional PRACH resources. For example, the configuration information may indicate a first PRACH configuration indicating the PRACH resources, and a second PRACH configuration indicating the additional PRACH resources. Each PRACH resource, for example, may correspond to a PRACH occasion (e.g., a time and frequency resource) in which the UE may transmit a PRACH communication.

In some aspects, the configuration information indicating the first PRACH configuration and the second PRACH configuration may be semi-static configuration information, such as in a SIB1 or an RRC message. In some aspects, a PRACH configuration may indicate a preamble format, a periodicity of PRACH resources indicated by the PRACH configuration, one or more subframe numbers that include the PRACH resources, or a starting symbol for the PRACH resources, among other examples.

In some aspects, the configuration information may include an indication of which of the additional PRACH resources are available for a PRACH transmission. For example, a PRACH resource that is available can be used by the UE as an RO, for SSB-to-RO mapping, or for a RACH preamble, among other examples.

In some aspects, the indication of which of the additional PRACH resources are available may be a PRACH masking index. The PRACH masking index may be associated with a PRACH mask to be applied to the additional PRACH resources. In some aspects, the PRACH mask may indicate a masking pattern that can be used to determine one or more of the additional PRACH resources that are masked (e.g., these masked PRACH resources may not be available for transmitting a PRACH communication).

For example, a masking pattern may indicate that a first or second half of a number of association periods in an association pattern period are masked, every even association period in an association pattern period is masked, every odd association period in an association pattern period is masked, or a quantity of consecutive association periods in a set of consecutive or non-consecutive reference windows are masked. In some aspects, a reference window may be a group or bundle of association pattern periods. As another example, the masking pattern may indicate that a first or a second half of a quantity of association pattern periods in a quantity of association pattern periods are masked, every even association pattern period in a quantity of association pattern periods are masked, every odd association pattern period in a quantity of association pattern periods are masked, or a quantity of consecutive association pattern periods in a set of consecutive or non-consecutive reference windows are masked.

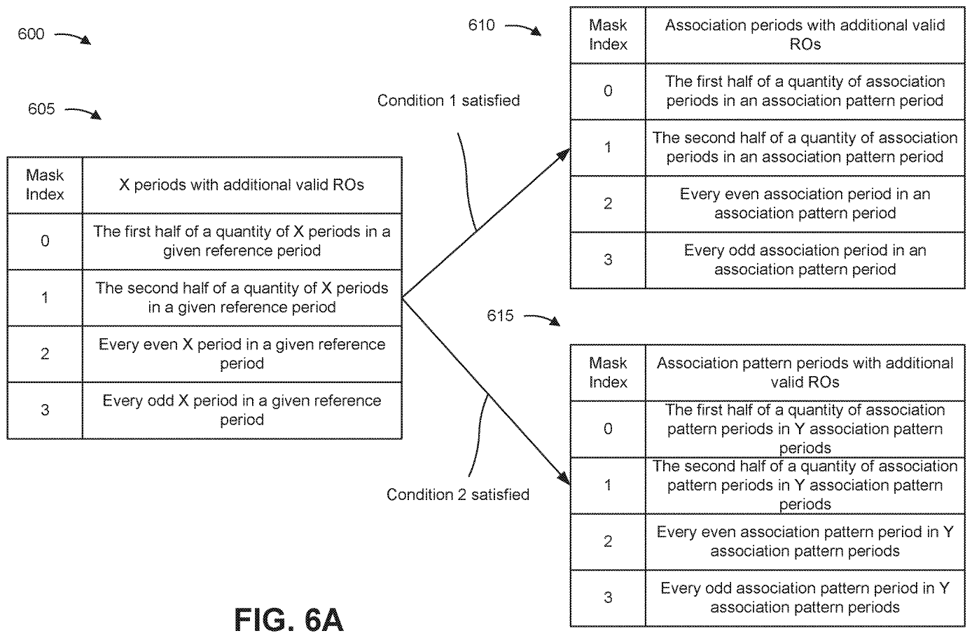

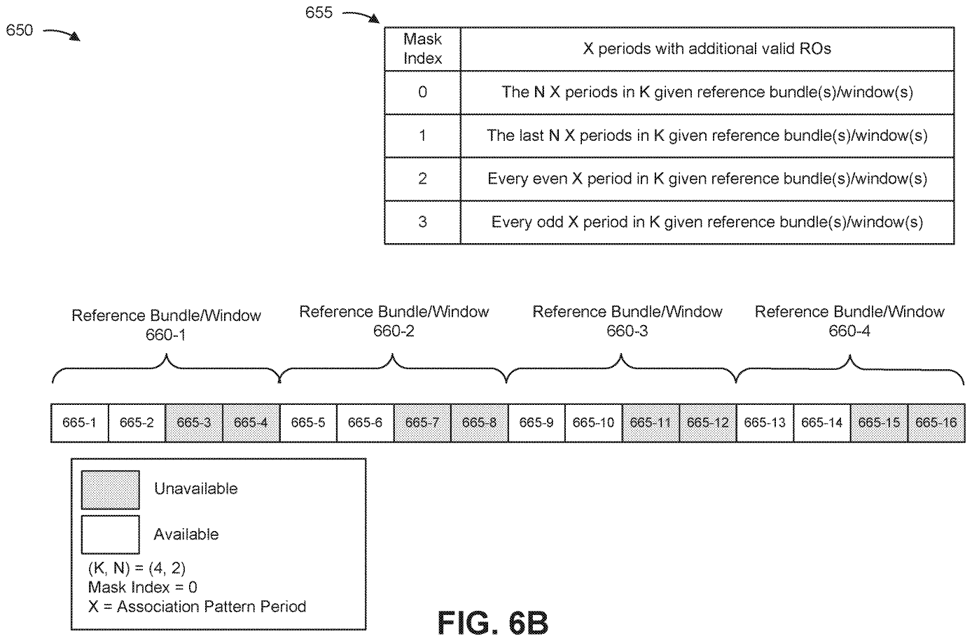

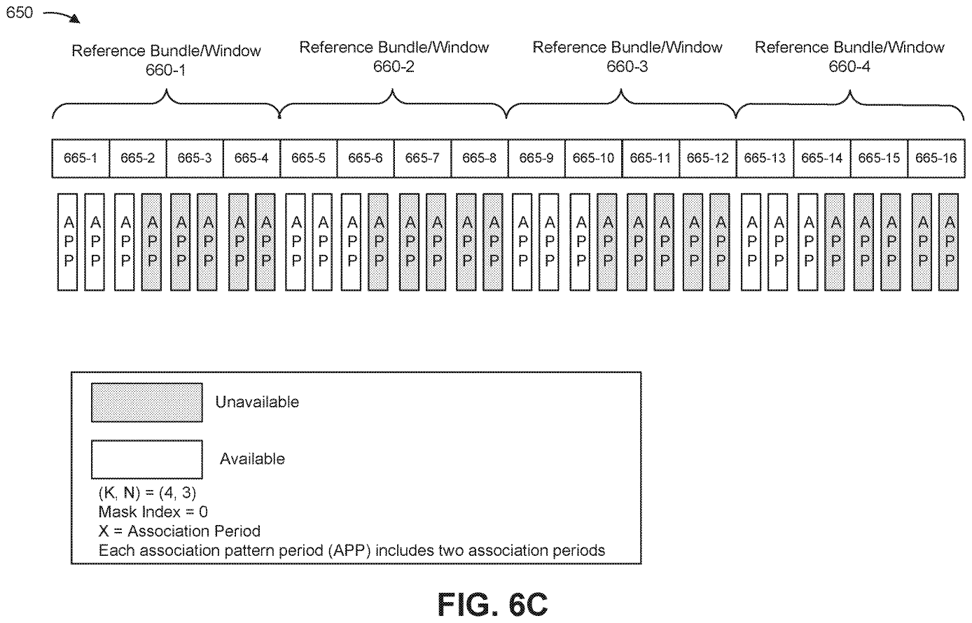

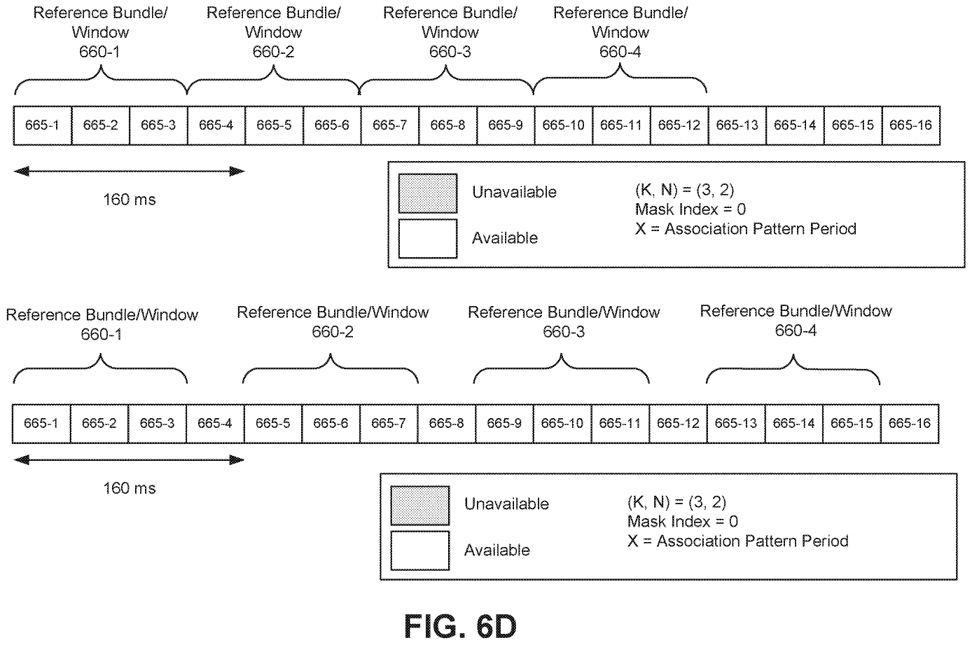

In some aspects, the masking pattern may be defined based at least in part on a generic table, a set of variables, a set of conditions, or a combination thereof. In these aspects, as shown by reference number 510, the UE 120 may determine a granularity of a PRACH mask associated with the PRACH mask index. In some aspects, the UE 120 may determine the granularity of the PRACH mask based at least in part on a generic table and a set of conditions, as described below with respect to FIGS. 6A-6D.

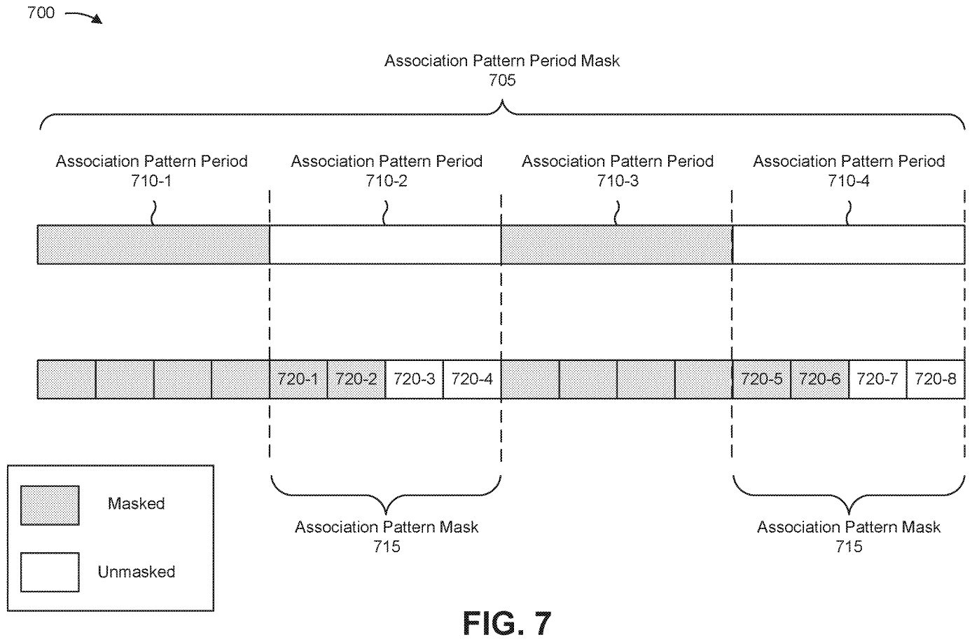

In some aspects, the indication of which additional PRACH resources are available may be a plurality of PRACH mask indexes. In some aspects, the UE 120 may determine which additional PRACH resources are available based at least in part on a superposition of a plurality of PRACH masks associated with the plurality of PRACH mask indexes, as described below with respect to FIG. 7.

As shown by reference number 515, the UE 120 may apply one or more PRACH masks to determine a set of PRACH resources. For example, the UE 120 may apply a masking pattern of a PRACH mask associated with the PRACH mask index to determine which PRACH occasions are available for PRACH transmission.

As shown by reference number 520, the UE 120 may transmit a PRACH communication using the determined set of PRACH resources. For example, the UE 120 may transmit a PRACH preamble in a PRACH occasion that is available based at least in part on the applied PRACH masks. In some aspects, the PRACH communication may be part of a random access procedure, such as the two-step or four-step random access procedure described in connection with FIGS. 2 and 3.

In some aspects, the PRACH transmission may include transmitting a PRACH preamble during an available PRACH occasion determined by the applied masks. In some aspects, the PRACH preamble may be an initial signal indicating an intention of the UE 120 to communicate with the network node 110. In some aspects, the PRACH communication may be a transmission of a different communication transmitted as part of the random access procedure.

As indicated above, FIG. 5 is provided as an example. Other examples may differ from what is described with regard to FIG. 5.

FIGS. 6A-6D are diagrams of examples 600 and 650 associated with utilizing a reference table to determine a granularity of a PRACH mask.

A granularity of a PRACH mask may refer to a level at which the PRACH mask operates. For example, a granularity of a PRACH mask may be an association period level and the PRACH mask may be utilized to mask association pattern periods (as described below with respect to the association pattern period mask 705 of FIG. 7). As another example, a granularity of a PRACH mask may be an association pattern period level and the PRACH mask may be utilized to mask association patterns (as described below with respect to the association pattern mask 715 of FIG. 7).

As shown in FIG. 6A, and by example 600, a reference table 605 may be used to associate PRACH mask indexes with reference masking patterns. In some aspects, a reference masking pattern may be used to determine one or more of the additional PRACH resources that are masked.

In some aspects, a reference masking pattern may include a set of variables that can have different values to define different granularities of the reference masking pattern. For example, a reference masking pattern may include a set of variables that can be set to a first set of values to indicate a masking pattern at an association period level and that can be set to a second set of values to indicate a masking pattern at an association pattern period level.

In some aspects, a variable of the set of variables may be a type of period (e.g., X period(s), as shown in FIG. 6A). In some aspects, the type of period may be an association period or an association pattern period.

In some aspects, a variable of the set of variables may be a given reference period. For example, a given reference period may be an association period or an association pattern period. In some aspects, a variable of the set of variables may be a quantity (e.g., Y, as shown in FIG. 6A) of a type of period.

In some aspects, a PRACH mask index may indicate the association periods with additional valid ROs when the first condition (e.g., Condition 1, as shown in FIG. 6A) is satisfied. For example, the PRACH mask index “0” may represent the first half of the number of association periods in an association pattern period, and the PRACH mask index “1” may represent the second half of the number of association periods in an association pattern period.

In some aspects, the first condition may be whether a quantity of association patterns included in an association period satisfies a threshold. For example, the first condition may be satisfied based at least in part the quantity of association patterns included in an association period satisfies (e.g., is greater than) a threshold (e.g., there are greater than N association patterns included in an association period). As another example, the first condition may not be satisfied based at least in part the quantity of association patterns included in an association period failing to satisfy (e.g., is less than or equal to) the threshold (e.g., there are a maximum of N association patterns included in an association period).

In some aspects, the PRACH mask index may determine the association periods with valid ROs based on the first condition. For example, the mask index “0” may correspond to masking the even-numbered association periods, while the mask index “1” may correspond to masking the odd-numbered association periods within an association pattern period. In some aspects, the PRACH mask index may specify the association periods with valid ROs when a specific condition is met. For example, the PRACH mask index “0” may indicate masking the first half of association periods, while PRACH mask index “1” may indicate masking the second half within an association pattern period.

In some aspects, a PRACH mask index may indicate the association pattern periods with additional valid ROs when a second condition (e.g., Condition 2, as shown in FIG. 6A) is satisfied. For example, the PRACH mask index “0” may represent the first half of the number of association pattern periods in Y association pattern periods, and the PRACH mask index “1” may represent the second half of the number of association pattern periods in Y association pattern periods.

In some aspects, the second condition may be whether a quantity of association patterns included in an association period satisfies a threshold. In some aspects, the second condition may be satisfied when the first condition is not satisfied. For example, the second condition may be satisfied based at least in part the quantity of association patterns included in an association period failing to satisfy (e.g., is less than or equal to) the threshold (e.g., there are a maximum of N association patterns included in an association period). As another example, the second condition may not be satisfied based at least in part the quantity of association patterns included in an association period satisfies (e.g., is greater than) the threshold (e.g., there are greater than N association patterns included in an association period).

In some aspects, the PRACH mask index may determine the association pattern periods with valid ROs based at least in part on the second condition. For example, the PRACH mask index “0” may correspond to masking the even-numbered association pattern periods, while the PRACH mask index “1” may correspond to masking the odd-numbered association pattern periods within a series of Y association pattern periods.

In some aspects, the PRACH mask index may specify the association pattern periods with valid ROs when another condition is satisfied. For example, the PRACH mask index “0” may indicate masking the first half of association pattern periods, while PRACH mask index “1” may indicate masking the second half within a series of Y association pattern periods.

In some aspects, a condition (e.g., the first condition or the second condition) may be whether a quantity of association patterns included in an association period satisfies a threshold. For example, the first condition may be satisfied based at least in part on the quantity of association patterns included in an association period satisfying the threshold, and the second condition may be satisfied based at least in part on the quantity of association patterns included in an association period failing to satisfy the threshold. In some aspects, table 610 may be used to define the masking pattern based at least in part on the first condition being satisfied, and table 615 may be used to define the masking pattern based at least in part on the second condition being satisfied.

As an example, as shown in reference table 605, mask index 0 may be associated with masking the first half of a quantity of association periods in an association pattern period when a first condition is satisfied, and may be associated with masking a first half of a quantity of association pattern periods in Y association pattern periods when a second condition (e.g., Condition 2, as shown in FIG. 6A) is satisfied.

As shown in reference table 605, mask index 1 may be associated with masking the second half of a quantity of association periods in an association pattern period when the first condition is satisfied and may be associated with masking a second half of a quantity of association pattern periods in Y association pattern periods when the second condition is satisfied.

As shown in reference table 605, mask index 2 may be associated with masking every even-numbered association period in an association pattern period when the first condition is satisfied and masking every even association pattern period in Y association pattern periods when the second condition is satisfied. In some aspects, each association pattern period may be associated with an association pattern index value. For example, a first association pattern period may be associated with an association pattern index value of 0, a second association pattern period may be associated with an association pattern index value of 1, and so on. If there are eight association periods in an association pattern period, mask index 2 may indicate that the association pattern periods associated with the association pattern indexes of 0, 2, 4, and 6 are masked when the first condition is satisfied.

As shown in reference table 605, mask index 3 may be associated with masking every odd-numbered association period in an association pattern period when the first condition is satisfied and masking every odd association pattern period in Y association pattern periods when the second condition is satisfied. For example, if there are eight association periods in an association pattern period, mask index 2 may indicate that the association pattern periods associated with the association pattern indexes of 1, 3, 5, and 7 are masked when the first condition is satisfied.

As shown in FIG. 6B, and by example 650, a reference table 655 may be used to associate PRACH mask indexes with reference masking patterns (also referred to herein as masking pattern configurations). In some aspects, a reference masking pattern or a masking pattern configuration may include a set of variables that can have different values to define different granularities of the reference masking pattern. For example, as shown in FIG. 6B, reference table 655 may include a first variable (N) to indicate a quantity periods, of a type of period (X), in a quantity (K) of reference bundle(s) or reference window(s) 660.

In some aspects, a reference bundle/window 660 may be a set of K consecutive association pattern periods. In some aspects, the quantity of reference bundles/windows 660 may be consecutive reference bundles/windows 660. For example, as shown in FIG. 6B, reference bundles/windows 660-1, 660-2, 660-3, and 660-4 may be consecutive in time. Stated differently, there is not a time gap between a last association pattern period 665 of a first reference bundle/window 660 and a first association pattern period 665 of a next reference bundle/window 660 (e.g., there is not a time gap between association pattern period 665-4 of reference bundle/window 660-1 and association pattern period 665-5 of reference bundle/window 660-2).

In some aspects, the quantity (K) of reference bundles/windows 660 may be non-consecutive in time. For example, one or more masked or unavailable reference bundles/windows 660 may occur in between two unmasked or available reference bundles/windows 660. As another example, one or more masked or unavailable association pattern periods (e.g., association pattern periods 665-4, 665-8, 665-12, and 665-16, as shown in FIG. 6D) may occur between two unmasked or available reference bundles/windows 660.

In some aspects, the quantity (K) may be configured via RRC signaling. In some aspects, the quantity (K) may be indicated in configuration information received from a network node (e.g., the configuration information received by the UE 120 from the network node 110 described above with respect to reference number 505 of FIG. 5).

In some aspects, the quantity (K) may not be configured. In these aspects, the quantity (K) may be set to a default quantity. For example, the quantity (K) may be set of a value of 1, 2, 3, or some other default integer value.

Similarly, in some aspects, the quantity (N) may be configured via RRC signaling. In some aspects, the quantity (N) may be indicated in configuration information received from a network node (e.g., the configuration information received by the UE 120 from the network node 110 described above with respect to reference number 505 of FIG. 5).

In some aspects, the quantity (N) may not be configured. In these aspects, the quantity (N) may be set to a default quantity. For example, the quantity (N) may be set of a value of 1, 2, 3, or some other default integer value.

In some aspects, the type of period (X) may be an association period (as shown in FIG. 6B) or an association pattern period (as shown in FIG. 6C). In some aspects, the type of period (X) may be configured via RRC signaling. In some aspects, the type of period (X) may be indicated in configuration information received from a network node (e.g., the configuration information received by the UE 120 from the network node 110 described above with respect to reference number 505 of FIG. 5).

In some aspects, the type of period (X) may not be configured. In these aspects, the type of period (X) may be set to a default type of period. For example, the type of period (X) may be set to an association period or an association pattern period based at least in part on the association period or the association pattern period being configured as a default type of period.

In some aspects, the quantity (K) may be configured to limit the reference period. In some aspects, the quantity (K) may be configured to cause an amount of time associated with the quantity (K) of reference windows/bundles to satisfy a threshold. For example, the quantity (K) may be configured to cause the amount of time associated with the quantity (K) of reference windows/bundles to equal to 160 ms.

In some aspects, the quantity (K) may be configured to cause an amount of time associated with the quantity (K) of reference windows/bundles to fail to satisfy (e.g., may be less than) the threshold. For example, as shown in FIG. 6D, the quantity (K) may be configured to cause an amount of time associated with the quantity (K) of reference windows/bundles to be less than 160 ms.

In some aspects, the reference bundle/windows 660 may be modified to be non-consecutive reference bundle/windows such that the mapping pattern is reset every threshold amount of time (e.g., 160 ms). In some aspects, the reference bundle/windows 660 may be modified to be non-consecutive reference bundle/windows by inserting an association pattern period 665 between, or outside of, consecutive reference bundle/windows 660. For example, as shown in FIG. 6D, association pattern period 665-4 may be inserted between reference bundle/window 660-1 and reference bundle window 660-2, association pattern period 665-8 may be inserted between reference bundle/window 660-2 and reference bundle window 660-3, association pattern period 665-12 may be inserted between reference bundle/window 660-3 and reference bundle window 660-4, and association pattern period 665-16 may be inserted after reference bundle window 660-4.

In some aspects, as shown in FIG. 6D, the inserted association pattern periods 665 may be unmasked or available association pattern periods. In some aspects, one or more of the inserted association pattern periods 665 may be masked or unavailable association pattern periods.

In some aspects, whether an inserted association pattern period 665 is masked or unmasked may be based at least in part on the indicated PRACH mask index. For example, the inserted association pattern periods 665 may be available or unavailable based at least in part on the PRACH mask index being an even value PRACH mask index, an odd value PRACH mask index, or a particular PRACH mask index (e.g., PRACH mask index 0, PRACH mask index 1, PRACH mask index 2, PRACH mask index 3, or the like). In some aspects, whether an inserted association pattern period 665 is masked or unmasked may be configured via RRC signaling. In some aspects, whether an inserted association pattern period 665 is masked or unmasked may be indicated in configuration information (e.g., the configuration information described above with respect to reference number 505 of FIG. 5).

As indicated above, FIGS. 6A-6D are provided as examples. Other examples may differ from what is described with regard to FIGS. 6A-6D.

FIG. 7 is a diagram of an example 700 associated with utilizing multiple PRACH masks for masking for PRACH resources.

In some aspects, PRACH configuration information (e.g., the configuration information described above with respect to FIG. 5) may indicate multiple PRACH mask indexes. For example, the PRACH configuration information may indicate a first PRACH mask index associated with a first PRACH mask (e.g., association pattern period mask 705, as shown in FIG. 7) having a first granularity and a second PRACH mask index associated with a second PRACH mask (e.g., association pattern mask 715, as shown in FIG. 7) having a second granularity.

In some aspects, an association pattern period mask 705 may be applied over multiple association pattern periods 710. For example, as shown in FIG. 7, the association pattern period mask 705 may indicate a masking pattern over a series of association pattern periods 710-1, 710-2, 710-3, and 710-4.

In some aspects, the association pattern period mask 705 may be used to determine which of the association pattern periods 710 are available for use. For example, as shown in FIG. 7, the association pattern period mask 705 may be used to mask association pattern periods 710-1 and 710-3. Stated differently, the association pattern period mask 705 may be used to indicate that association pattern periods 710-2, 710-4 are available for use.

In some aspects, an association pattern period 710 may include multiple association periods 720. For example, as shown in FIG. 7, association pattern period 710-1 may include association periods 720-1, 720-2, 720-3, and 720-4. Similarly, association pattern periods 710-2, 710-3, and 710-4 may each include multiple association periods. For example, as shown in FIG. 7, association pattern period 710-4 includes association periods 720-5, 720-6, 720-7, and 720-8.

In some aspects, an association pattern mask 715 may be applied within an unmasked association pattern period 710. For example, as shown in FIG. 7, association pattern mask 715 may indicate a masking pattern over a series of association periods within association pattern periods 710-2, 710-4. In this example, association pattern mask 715 may be applied within association pattern period 710-2 to determine which of the association periods 720-1, 720-2, 720-3, and 720-4 are available (e.g., association periods 720-3, 720-4, as shown in FIG. 7). Similarly, association pattern mask 715 may be applied within association pattern period 710-4 to determine which of the association periods 720-5, 720-6, 720-7, and 720-8 are available (e.g., association periods 720-7, 720-8, as shown in FIG. 7).

As indicated above, FIG. 7 is provided as an example. Other examples may differ from what is described with regard to FIG. 7.

FIG. 8 is a diagram illustrating an example process 800 performed, for example, at a UE or an apparatus of a UE. Example process 800 is an example where the apparatus or the UE (e.g., UE 120) performs operations associated with adaptive and layered masking for PRACH resources.

As shown in FIG. 8, in some aspects, process 800 may include receiving configuration information that indicates a PRACH mask index, wherein a granularity of the PRACH mask index is determined based at least in part on whether a condition is satisfied (block 810). For example, the UE (e.g., using reception component 1402 or communication manager 1406, depicted in FIG. 14) may receive configuration information that indicates a PRACH mask index, wherein a granularity of the PRACH mask index is determined based at least in part on whether a condition is satisfied, as described above.

As further shown in FIG. 8, in some aspects, process 800 may include transmitting a PRACH communication via a set of PRACH resources, wherein the set of PRACH resources are determined based at least in part on the granularity of the PRACH mask index (block 820). For example, the UE (e.g., using transmission component 1404 or communication manager 1406, depicted in FIG. 14) may transmit a PRACH communication via a set of PRACH resources, wherein the set of PRACH resources are determined based at least in part on the granularity of the PRACH mask index, as described above.

Process 800 may include additional aspects, such as any single aspect or any combination of aspects described below or in connection with one or more other processes described elsewhere herein.

In a first aspect, the granularity of the PRACH mask index comprises an association period level or an association pattern period level.

In a second aspect, alone or in combination with the first aspect, the condition is satisfied based at least in part on whether a quantity of association periods included in an association pattern period satisfies a threshold.

In a third aspect, alone or in combination with one or more of the first and second aspects, the PRACH mask index is associated with a masking pattern for determining the granularity of the PRACH mask index, wherein the masking pattern is associated with a first set of parameters or a second set of parameters based at least in part on whether the condition is satisfied.

In a fourth aspect, alone or in combination with one or more of the first through third aspects, the masking pattern is based at least in part on a reference period, wherein a type of the reference period is determined based at least in part on the first set of parameters or the second set of parameters.

In a fifth aspect, alone or in combination with one or more of the first through fourth aspects, the reference period comprises an association period based at least in part on the masking pattern being associated with the first set of parameters, and the reference period comprises an association pattern period based at least in part on the masking pattern being associated with the second set of parameters.

In a sixth aspect, alone or in combination with one or more of the first through fifth aspects, the masking pattern comprises a first half of a quantity of a type of period in a given reference period, a second half of the quantity of the type of period in the given reference period, every period, of the type of period, in the given reference period that is associated with an even index number, or every period, of the type of period, in the given reference period that is associated with an odd index number.

In a seventh aspect, alone or in combination with one or more of the first through sixth aspects, the type of period comprises an association period based at least in part on the masking pattern being associated with the first set of parameters, and the type of period comprises an association pattern period based at least in part on the masking pattern being associated with the second set of parameters.

In an eighth aspect, alone or in combination with one or more of the first through seventh aspects, the first set of parameters is associated with masking association periods and the second set of parameters is associated with masking association pattern periods.

In a ninth aspect, alone or in combination with one or more of the first through eighth aspects, the condition comprises a first condition and a second condition, wherein the granularity of the PRACH mask index is determined to be an association period level granularity based at least in part on a satisfaction of the first condition, and wherein the granularity of the PRACH is determined to be an association pattern period level granularity based at least in part on a satisfaction of the second condition.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE. Example process 900 is an example where the apparatus or the UE (e.g., UE 120) performs operations associated with adaptive and layered masking for PRACH resources.

As shown in FIG. 9, in some aspects, process 900 may include receiving configuration information indicating two or more PRACH mask indexes (block 910). For example, the UE (e.g., using reception component 1402 or communication manager 1406, depicted in FIG. 14) may receive configuration information indicating two or more PRACH mask indexes, as described above.

As further shown in FIG. 9, in some aspects, process 900 may include transmitting a PRACH communication via a set of resources, wherein the set of resources are determined based at least in part on a superposition of two or more PRACH masks associated with the two or more PRACH mask indexes (block 920). For example, the UE (e.g., using transmission component 1404 or communication manager 1406, depicted in FIG. 14) may transmit a PRACH communication via a set of resources, wherein the set of resources are determined based at least in part on a superposition of two or more PRACH masks associated with the two or more PRACH mask indexes, as described above.

Process 900 may include additional aspects, such as any single aspect or any combination of aspects described below or in connection with one or more other processes described elsewhere herein.

In a first aspect, the two or more PRACH masks include a first PRACH mask and a second PRACH mask, and the first PRACH mask is associated with masking association periods and the second PRACH mask is associated with masking association pattern periods.

In a second aspect, alone or in combination with the first aspect, the first PRACH mask is applied to mask a set of association periods of a plurality of association periods, and the second PRACH mask is applied to mask association pattern periods included in unmasked association periods of the plurality of association periods.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node. Example process 1000 is an example where the apparatus or the network node (e.g., network node 110) performs operations associated with adaptive and layered masking for PRACH resources.

As shown in FIG. 10, in some aspects, process 1000 may include transmitting configuration information that indicates a PRACH mask index, wherein a granularity of the PRACH mask index is determined based at least in part on whether a condition is satisfied (block 1010). For example, the network node (e.g., using transmission component 1504 or communication manager 1506, depicted in FIG. 15) may transmit configuration information that indicates a PRACH mask index, wherein a granularity of the PRACH mask index is determined based at least in part on whether a condition is satisfied, as described above.

As further shown in FIG. 10, in some aspects, process 1000 may include receiving a PRACH communication via a set of PRACH resources, wherein the set of PRACH resources are determined based at least in part on the granularity of the PRACH mask index (block 1020). For example, the network node (e.g., using reception component 1502 or communication manager 1506, depicted in FIG. 15) may receive a PRACH communication via a set of PRACH resources, wherein the set of PRACH resources are determined based at least in part on the granularity of the PRACH mask index, as described above.

Process 1000 may include additional aspects, such as any single aspect or any combination of aspects described below or in connection with one or more other processes described elsewhere herein.

In a first aspect, the granularity of the PRACH mask index comprises an association period level or an association pattern period level.

In a second aspect, alone or in combination with the first aspect, the condition is satisfied based at least in part on whether a quantity of association periods included in an association pattern period satisfies a threshold.

In a third aspect, alone or in combination with one or more of the first and second aspects, the PRACH mask index is associated with a masking pattern for determining the granularity of the PRACH mask index, wherein the masking pattern is associated with a first set of parameters or a second set of parameters based at least in part on whether the condition is satisfied.

In a fourth aspect, alone or in combination with one or more of the first through third aspects, the masking pattern is based at least in part on a reference period, wherein a type of the reference period is determined based at least in part on the first set of parameters or the second set of parameters.

In a fifth aspect, alone or in combination with one or more of the first through fourth aspects, the type of the reference period comprises an association period based at least in part on the masking pattern being associated with the first set of parameters, and the type of the reference period comprises an association pattern period based at least in part on the masking pattern being associated with the second set of parameters.

In a sixth aspect, alone or in combination with one or more of the first through fifth aspects, the masking pattern comprises a first half of a quantity of a type of period in a given reference period, a second half of the quantity of the type of period in the given reference period, every period, of the type of period, in the given reference period that is associated with an even index number, or every period, of the type of period, in the given reference period that is associated with an odd index number.

In a seventh aspect, alone or in combination with one or more of the first through sixth aspects, the type of period comprises an association period based at least in part on the masking pattern being associated with the first set of parameters, and the type of period comprises an association pattern period based at least in part on the masking pattern being associated with the second set of parameters.

In an eighth aspect, alone or in combination with one or more of the first through seventh aspects, the first set of parameters is associated with masking association periods and the second set of parameters is associated with masking association pattern periods.

In a ninth aspect, alone or in combination with one or more of the first through eighth aspects, the condition comprises a first condition and a second condition, wherein the granularity of the PRACH mask index is determined to be an association period level granularity based at least in part on a satisfaction of the first condition, and wherein the granularity of the PRACH is determined to be an association pattern period level granularity based at least in part on a satisfaction of the second condition.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with adaptive and layered masking for PRACH resources.

As shown in FIG. 11, in some aspects, process 1100 may include transmitting configuration information indicating two or more PRACH mask indexes (block 1110). For example, the network node (e.g., using transmission component 1504 or communication manager 1506, depicted in FIG. 15) may transmit configuration information indicating two or more PRACH mask indexes, as described above.

As further shown in FIG. 11, in some aspects, process 1100 may include receiving a PRACH communication via a set of resources, wherein the set of resources are determined based at least in part on a superposition of two or more PRACH masks associated with the two or more PRACH mask indexes (block 1120). For example, the network node (e.g., using reception component 1502 or communication manager 1506, depicted in FIG. 15) may receive a PRACH communication via a set of resources, wherein the set of resources are determined based at least in part on a superposition of two or more PRACH masks associated with the two or more PRACH mask indexes, as described above.

Process 1100 may include additional aspects, such as any single aspect or any combination of aspects described below or in connection with one or more other processes described elsewhere herein.

In a first aspect, the two or more PRACH masks include a first PRACH mask and a second PRACH mask, and the first PRACH mask is associated with masking association periods and the second PRACH mask is associated with masking association pattern periods.

In a second aspect, alone or in combination with the first aspect, the first PRACH mask is applied to mask a set of association periods of a plurality of association periods, and the second PRACH mask is applied to mask association pattern periods included in unmasked association periods of the plurality of association periods.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

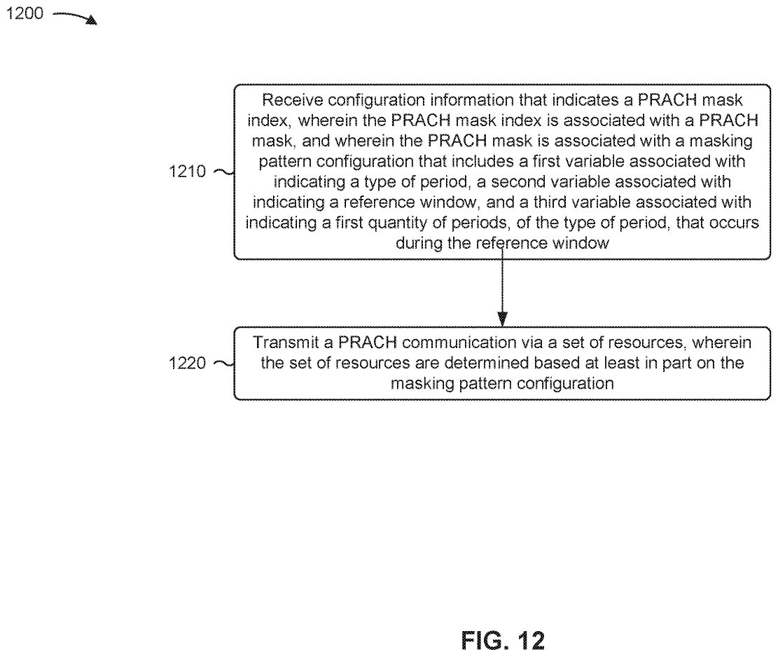

FIG. 12 is a diagram illustrating an example process 1200 performed, for example, at a UE or an apparatus of a UE. Example process 1200 is an example where the apparatus or the UE (e.g., UE 120) performs operations associated with adaptive and layered masking for PRACH resources.

As shown in FIG. 12, in some aspects, process 1200 may include receiving configuration information that indicates a PRACH mask index, wherein the PRACH mask index is associated with a PRACH mask, and wherein the PRACH mask is associated with a masking pattern configuration that includes a first variable associated with indicating a type of period, a second variable associated with indicating a reference window, and a third variable associated with indicating a first quantity of periods, of the type of period, that occurs during the reference window (block 1210). For example, the UE (e.g., using reception component 1402 or communication manager 1406, depicted in FIG. 14) may receive configuration information that indicates a PRACH mask index, wherein the PRACH mask index is associated with a PRACH mask, and wherein the PRACH mask is associated with a masking pattern configuration that includes a first variable associated with indicating a type of period, a second variable associated with indicating a reference window, and a third variable associated with indicating a first quantity of periods, of the type of period (e.g., an association period or an association pattern period), that occurs during the reference window, as described above.

As further shown in FIG. 12, in some aspects, process 1200 may include transmitting a PRACH communication via a set of PRACH resources, wherein the set of PRACH resources are determined based at least in part on the masking pattern (block 1220). For example, the UE (e.g., using transmission component 1404 or communication manager 1406, depicted in FIG. 14) may transmit a PRACH communication via a set of PRACH resources, wherein the set of PRACH resources are determined based at least in part on the masking pattern, as described above.

Process 1200 may include additional aspects, such as any single aspect or any combination of aspects described below or in connection with one or more other processes described elsewhere herein.

In a first aspect, the reference window comprises a set of a second quantity of association pattern periods.

In a second aspect, one or more of the first quantity or the second quantity is configured via radio resource control signaling.

In a third aspect, the first quantity comprises a first default quantity when the first quantity is not configured for the UE, and wherein the second quantity comprises a second default quantity when the second quantity is not configured at the UE.

In a fourth aspect, the second quantity is configured to prevent the reference period from spanning across more than a threshold amount of time.

In a fifth aspect, the threshold amount of time is 160 milliseconds.

In a sixth aspect, the second quantity causes the reference period to span across less than a threshold amount of time, and wherein one or more of the type of period is inserted between consecutive reference time windows to cause the mapping pattern to reset at a periodicity equal to the threshold amount of time.

In a seventh aspect, the one or more of the type of period inserted between the consecutive reference time windows are associated with a set of masked resources that are not available for transmitting the PRACH communication.

In an eighth aspect, the one or more of the type of period inserted between the consecutive reference time windows are associated with a set of unmasked resources that are available for transmitting the PRACH communication.

In a ninth aspect, whether the one or more of the type of period inserted between the consecutive reference time windows are available or not available for transmitting the PRACH communication is based at least in part on a value of the PRACH mask index.

In a tenth aspect, whether the one or more of the type of period inserted between the consecutive reference time windows are available or not available for transmitting the PRACH communication is configured via radio resource control signaling.

In an eleventh aspect, the masking pattern repeats over time, and wherein the reference window and a next reference window are consecutive reference windows or non-consecutive reference windows.

In a twelfth aspect, the type of period comprises an association period or an association pattern period.

In a thirteenth aspect, the type of period comprises the association period or the association pattern period based at least in part on whether the type of period is configured for the UE.

In a fourteenth aspect, the type of period is configured via radio resource control signaling.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

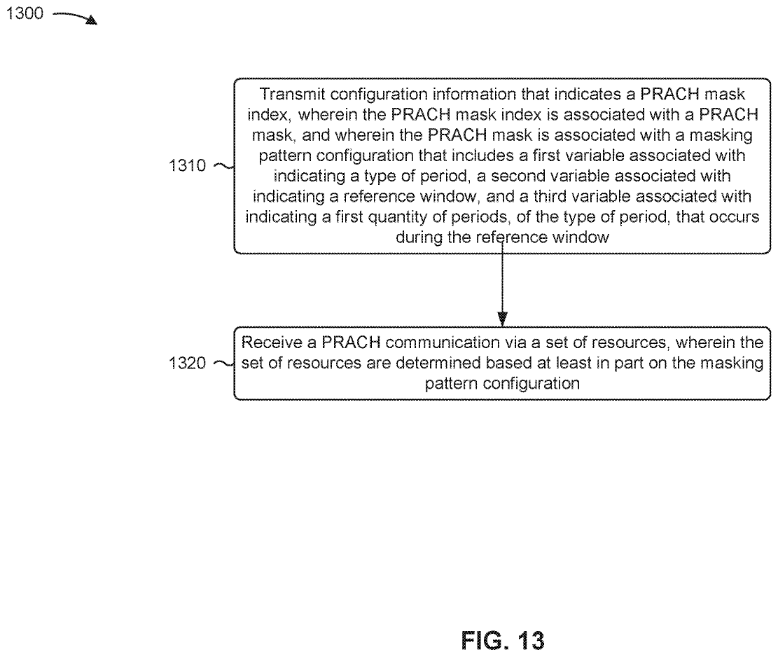

FIG. 13 is a diagram illustrating an example process 1300 performed, for example, at a network node or an apparatus of a network node. Example process 1300 is an example where the apparatus or the network node (e.g., network node 110) performs operations associated with adaptive and layered masking for PRACH resources.

As shown in FIG. 13, in some aspects, process 1300 may include receiving configuration information that indicates a PRACH mask index, wherein the PRACH mask index is associated with a PRACH mask, and wherein the PRACH mask is associated with a masking pattern configuration that includes a first variable associated with indicating a type of period, a second variable associated with indicating a reference window, and a third variable associated with indicating a first quantity of periods, of the type of period, that occurs during the reference window (block 1310). For example, the network node (e.g., using reception component 1502 or communication manager 1506, depicted in FIG. 15) may receive configuration information that indicates a PRACH mask index, wherein the PRACH mask index is associated with a PRACH mask, and wherein the PRACH mask is associated with a masking pattern configuration that includes a first variable associated with indicating a type of period, a second variable associated with indicating a reference window, and a third variable associated with indicating a first quantity of periods, of the type of period (e.g., an association period or an association pattern period), that occurs during the reference window, as described above.

As further shown in FIG. 13, in some aspects, process 1300 may include transmitting a PRACH communication via a set of PRACH resources, wherein the set of PRACH resources are determined based at least in part on the masking pattern configuration (block 1320). For example, the network node (e.g., using transmission component 1504 or communication manager 1506, depicted in FIG. 15) may transmit a PRACH communication via a set of PRACH resources, wherein the set of PRACH resources are determined based at least in part on the masking pattern configuration, as described above.

Process 1300 may include additional aspects, such as any single aspect or any combination of aspects described below or in connection with one or more other processes described elsewhere herein.

In a first aspect, the reference window comprises a set of a second quantity of association pattern periods.

In a second aspect, one or more of the first quantity or the second quantity is configured via radio resource control signaling.

In a third aspect, the first quantity comprises a first default quantity when the first quantity is not configured for a UE, and wherein the second quantity comprises a second default quantity when the second quantity is not configured at the UE.

In a fourth aspect, the second quantity is configured to prevent the reference period from spanning across more than a threshold amount of time.

In a fifth aspect, the threshold amount of time is 160 milliseconds.

In a sixth aspect, the second quantity causes the reference period to span across less than a threshold amount of time, and wherein one or more of the type of period is inserted between consecutive reference time windows to cause the mapping pattern to reset at a periodicity equal to the threshold amount of time.

In a seventh aspect, the one or more of the type of period inserted between the consecutive reference time windows are associated with a set of masked resources that are not available for transmitting the PRACH communication.

In an eighth aspect, the one or more of the type of period inserted between the consecutive reference time windows are associated with a set of unmasked resources that are available for transmitting the PRACH communication.

In a ninth aspect, whether the one or more of the type of period inserted between the consecutive reference time windows are available or not available for transmitting the PRACH communication is based at least in part on a value of the PRACH mask index.

In a tenth aspect, whether the one or more of the type of period inserted between the consecutive reference time windows are available or not available for transmitting the PRACH communication is configured via radio resource control signaling.

In an eleventh aspect, the masking pattern repeats over time, and wherein the reference window and a next reference window are consecutive reference windows or non-consecutive reference windows.

In a twelfth aspect, the type of period comprises an association period or an association pattern period.

In a thirteenth aspect, the type of period comprises the association period or the association pattern period based at least in part on whether the type of period is configured for the UE.

In a fourteenth aspect, the type of period is configured via radio resource control signaling.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a UE, or a UE may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 140 described in connection with FIG. 1) of the UE.

In some aspects, the apparatus 1400 may be configured to perform one or more operations described herein in connection with FIGS. 1-7. Additionally, or alternatively, the apparatus 1400 may be configured to perform one or more processes described herein, such as process 800 of FIG. 8, process 900 of FIG. 9, or a combination thereof. In some aspects, the apparatus 1400 or one or more components shown in FIG. 14 may include one or more components of the UE described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the UE described above in connection with FIG. 1, such as a radio, one or more RF chains, one or more transceivers, or one or more modems, each of which may in turn be coupled with one or more antennas of the UE.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The reception component 1402 may receive configuration information that indicates a PRACH mask index, wherein a granularity of the PRACH mask index is determined based at least in part on whether a condition is satisfied. The transmission component 1404 may transmit a PRACH communication via a set of PRACH resources, wherein the set of PRACH resources are determined based at least in part on the granularity of the PRACH mask index.

The reception component 1402 may receive configuration information indicating two or more PRACH mask indexes. The transmission component 1404 may transmit a PRACH communication via a set of resources, wherein the set of resources are determined based at least in part on a superposition of two or more PRACH masks associated with the two or more PRACH mask indexes.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a network node, or a network node may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the network node.

In some aspects, the apparatus 1500 may be configured to perform one or more operations described herein in connection with FIGS. 1-7. Additionally, or alternatively, the apparatus 1500 may be configured to perform one or more processes described herein, such as process 1000 of FIG. 10, process 1100 of FIG. 11, or a combination thereof. In some aspects, the apparatus 1500 or one or more components shown in FIG. 15 may include one or more components of the network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network node described above in connection with FIG. 1, such as a radio, one or more RF chains, one or more transceivers, or one or more modems, each of which may in turn be coupled with one or more antennas of the network node. In some aspects, the reception component 1502 or the transmission component 1504 may include or may be included in a network interface. The network interface may be configured to obtain or output signals for the apparatus 1500 via one or more communications links, such as a backhaul link, a midhaul link, or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The transmission component 1504 may transmit configuration information that indicates a PRACH mask index, wherein a granularity of the PRACH mask index is determined based at least in part on whether a condition is satisfied. The reception component 1502 may receive a PRACH communication via a set of PRACH resources, wherein the set of PRACH resources are determined based at least in part on the granularity of the PRACH mask index.

The transmission component 1504 may transmit configuration information indicating two or more PRACH mask indexes. The reception component 1502 may receive a PRACH communication via a set of resources, wherein the set of resources are determined based at least in part on a superposition of two or more PRACH masks associated with the two or more PRACH mask indexes.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a UE, comprising: receiving configuration information that indicates a PRACH mask index, wherein a granularity of the PRACH mask index is determined based at least in part on whether a condition is satisfied; and transmitting a PRACH communication via a set of PRACH resources, wherein the set of PRACH resources are determined based at least in part on the granularity of the PRACH mask index.
Aspect 2: The method of Aspect 1, wherein the granularity of the PRACH mask index comprises an association period level or an association pattern period level.
Aspect 3: The method of any of Aspects 1-2, wherein the condition is satisfied based at least in part on whether a quantity of association periods included in an association pattern period satisfies a threshold.
Aspect 4: The method of any of Aspects 1-3, wherein the PRACH mask index is associated with a masking pattern for determining the granularity of the PRACH mask index, wherein the masking pattern is associated with a first set of parameters or a second set of parameters based at least in part on whether the condition is satisfied.
Aspect 5: The method of Aspect 4, wherein the masking pattern is based at least in part on a reference period, wherein a type of the reference period is determined based at least in part on the first set of parameters or the second set of parameters.
Aspect 6: The method of Aspect 5, wherein the reference period comprises an association period based at least in part on the masking pattern being associated with the first set of parameters, and wherein the reference period comprises an association pattern period based at least in part on the masking pattern being associated with the second set of parameters.
Aspect 7: The method of Aspect 4, wherein the masking pattern comprises: a first half of a quantity of a type of period in a given reference period, a second half of the quantity of the type of period in the given reference period, every period, of the type of period, in the given reference period that is associated with an even index number, or every period, of the type of period, in the given reference period that is associated with an odd index number.
Aspect 8: The method of Aspect 7, wherein the type of period comprises an association period based at least in part on the masking pattern being associated with the first set of parameters, and wherein the type of period comprises an association pattern period based at least in part on the masking pattern being associated with the second set of parameters.
Aspect 9: The method of Aspect 4, wherein the first set of parameters is associated with masking association periods and the second set of parameters is associated with masking association pattern periods.
Aspect 10: The method of any of Aspects 1-9, wherein the condition comprises a first condition and a second condition, wherein the granularity of the PRACH mask index is determined to be an association period level granularity based at least in part on a satisfaction of the first condition, and wherein the granularity of the PRACH is determined to be an association pattern period level granularity based at least in part on a satisfaction of the second condition.
Aspect 11: A method of wireless communication performed by a UE, comprising: receiving configuration information indicating two or more PRACH mask indexes; and transmitting a PRACH communication via a set of resources, wherein the set of resources are determined based at least in part on a superposition of two or more PRACH masks associated with the two or more PRACH mask indexes.
Aspect 12: The method of Aspect 11, wherein the two or more PRACH masks include a first PRACH mask and a second PRACH mask, and wherein the first PRACH mask is associated with masking association periods and the second PRACH mask is associated with masking association pattern periods.
Aspect 13: The method of Aspect 12, wherein the first PRACH mask is applied to mask a set of association periods of a plurality of association periods, and wherein the second PRACH mask is applied to mask association pattern periods included in unmasked association periods of the plurality of association periods.
Aspect 14: A method of wireless communication performed by a network node, comprising: transmitting configuration information that indicates a PRACH mask index, wherein a granularity of the PRACH mask index is determined based at least in part on whether a condition is satisfied; and receiving a PRACH communication via a set of PRACH resources, wherein the set of PRACH resources are determined based at least in part on the granularity of the PRACH mask index.
Aspect 15: The method of Aspect 14, wherein the granularity of the PRACH mask index comprises an association period level or an association pattern period level.
Aspect 16: The method of any of Aspects 14-15, wherein the condition is satisfied based at least in part on whether a quantity of association periods included in an association pattern period satisfies a threshold.
Aspect 17: The method of any of Aspects 14-16, wherein the PRACH mask index is associated with a masking pattern for determining the granularity of the PRACH mask index, wherein the masking pattern is associated with a first set of parameters or a second set of parameters based at least in part on whether the condition is satisfied.
Aspect 18: The method of Aspect 17, wherein the masking pattern is based at least in part on a reference period, wherein a type of the reference period is determined based at least in part on the first set of parameters or the second set of parameters.
Aspect 19: The method of Aspect 18, wherein the type of the reference period comprises an association period based at least in part on the masking pattern being associated with the first set of parameters, and wherein the type of the reference period comprises an association pattern period based at least in part on the masking pattern being associated with the second set of parameters.
Aspect 20: The method of Aspect 17, wherein the masking pattern comprises: a first half of a quantity of a type of period in a given reference period, a second half of the quantity of the type of period in the given reference period, every period, of the type of period, in the given reference period that is associated with an even index number, or every period, of the type of period, in the given reference period that is associated with an odd index number.
Aspect 21: The method of Aspect 20, wherein the type of period comprises an association period based at least in part on the masking pattern being associated with the first set of parameters, and wherein the type of period comprises an association pattern period based at least in part on the masking pattern being associated with the second set of parameters.
Aspect 22: The method of Aspect 17, wherein the first set of parameters is associated with masking association periods and the second set of parameters is associated with masking association pattern periods.
Aspect 23: The method of any of Aspects 14-22, wherein the condition comprises a first condition and a second condition, wherein the granularity of the PRACH mask index is determined to be an association period level granularity based at least in part on a satisfaction of the first condition, and wherein the granularity of the PRACH is determined to be an association pattern period level granularity based at least in part on a satisfaction of the second condition.
Aspect 24: A method of wireless communication performed by a network node, comprising: transmitting configuration information indicating two or more PRACH mask indexes; and receiving a PRACH communication via a set of resources, wherein the set of resources are determined based at least in part on a superposition of two or more PRACH masks associated with the two or more PRACH mask indexes.
Aspect 25: The method of Aspect 24, wherein the two or more PRACH masks include a first PRACH mask and a second PRACH mask, and wherein the first PRACH mask is associated with masking association periods and the second PRACH mask is associated with masking association pattern periods.
Aspect 26: The method of Aspect 25, wherein the first PRACH mask is applied to mask a set of association periods of a plurality of association periods, and wherein the second PRACH mask is applied to mask association pattern periods included in unmasked association periods of the plurality of association periods.
Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.
Aspect 28: An apparatus for wireless communication at a device, the apparatus comprising one or more memories and one or more processors coupled to the one or more memories, the one or more processors configured to cause the device to perform the method of one or more of Aspects 1-26.
Aspect 29: An apparatus for wireless communication, the apparatus comprising at least one means for performing the method of one or more of Aspects 1-26.
Aspect 30: A non-transitory computer-readable medium storing code for wireless communication, the code comprising instructions executable by one or more processors to perform the method of one or more of Aspects 1-26.
Aspect 31: A non-transitory computer-readable medium storing a set of instructions for wireless communication, the set of instructions comprising one or more instructions that, when executed by one or more processors of a device, cause the device to perform the method of one or more of Aspects 1-26.
Aspect 32: A device for wireless communication, the device comprising a processing system that includes one or more processors and one or more memories coupled with the one or more processors, the processing system configured to cause the device to perform the method of one or more of Aspects 1-26.
Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.
Aspect 34: A device comprising a processing system that includes one or more processors and one or more code-storing memories coupled with the one or more processors, the processing system configured to cause the device to perform the method of one or more of Aspects 1-26.
Aspect 35: A device comprising a processing system that includes processor circuitry and code-storing memory circuitry, the processing system configured to cause the device to perform the method of one or more of Aspects 1-26.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
one or more antennas; and
a processing system that includes one or more processors and one or more memories that store code and are coupled with the one or more processors, the processing system configured to cause the UE to:
wirelessly receive, from a network node, configuration information that indicates a physical random access channel (PRACH) mask index, wherein a granularity of the PRACH mask index is determined based at least in part on whether a condition is satisfied; and
wirelessly transmit, to the network node, a PRACH communication via a set of PRACH resources, wherein the set of PRACH resources are determined based at least in part on the granularity of the PRACH mask index.

2. The UE of claim 1, wherein the granularity of the PRACH mask index comprises an association period level or an association pattern period level.

3. The UE of claim 1, wherein the condition is satisfied based at least in part on whether a quantity of association periods included in an association pattern period satisfies a threshold.

4. The UE of claim 1, wherein the PRACH mask index is associated with a masking pattern for determining the granularity of the PRACH mask index, wherein the masking pattern is associated with a first set of parameters or a second set of parameters based at least in part on whether the condition is satisfied, wherein the masking pattern is based at least in part on a reference period, and wherein a type of the reference period is determined based at least in part on the first set of parameters or the second set of parameters.

5. The UE of claim 4, wherein the reference period comprises an association period based at least in part on the masking pattern being associated with the first set of parameters, and wherein the reference period comprises an association pattern period based at least in part on the masking pattern being associated with the second set of parameters.

6. The UE of claim 4, wherein the masking pattern comprises:
a first half of a quantity of a type of period in a given reference period,
a second half of the quantity of the type of period in the given reference period,
every period, of the type of period, in the given reference period that is associated with an even index number, or
every period, of the type of period, in the given reference period that is associated with an odd index number, wherein the type of period comprises an association period based at least in part on the masking pattern being associated with the first set of parameters, and wherein the type of period comprises an association pattern period based at least in part on the masking pattern being associated with the second set of parameters.

7. The UE of claim 4, wherein the first set of parameters is associated with masking association periods and the second set of parameters is associated with masking association pattern periods.

8. The UE of claim 1, wherein the condition comprises a first condition and a second condition, wherein the granularity of the PRACH mask index is determined to be an association period level granularity based at least in part on a satisfaction of the first condition, and wherein the granularity of the PRACH is determined to be an association pattern period level granularity based at least in part on a satisfaction of the second condition.

9. A UE, comprising:
one or more antennas; and
a processing system that includes one or more processors and one or more memories that store code and are coupled with the one or more processors, the processing system configured to cause the UE to:
wirelessly receive, from a network node, configuration information indicating two or more physical random access channel (PRACH) mask indexes; and
wirelessly transmit, to the network node, a PRACH communication via a set of resources, wherein the set of resources are determined based at least in part on a superposition of two or more PRACH masks associated with the two or more PRACH mask indexes.

10. The UE of claim 9, wherein the two or more PRACH masks include a first PRACH mask and a second PRACH mask, and wherein the first PRACH mask is associated with masking association periods and the second PRACH mask is associated with masking association pattern periods.

11. The UE of claim 10, wherein the first PRACH mask is applied to mask a set of association periods of a plurality of association periods, and wherein the second PRACH mask is applied to mask association pattern periods included in unmasked association periods of the plurality of association periods.

12. A network node, comprising:
a plurality of antennas; and
a processing system that includes one or more processors and one or more memories that store code and are coupled with the one or more processors, the processing system configured to cause the network node to:
wirelessly transmit, to a user equipment (UE), configuration information that indicates a physical random access channel (PRACH) mask index, wherein a granularity of the PRACH mask index is determined based at least in part on whether a condition is satisfied; and
wirelessly receive, from the UE, a PRACH communication via a set of PRACH resources, wherein the set of PRACH resources are determined based at least in part on the granularity of the PRACH mask index.

13. The network node of claim 12, wherein the granularity of the PRACH mask index comprises an association period level or an association pattern period level.

14. The network node of claim 12, wherein the condition is satisfied based at least in part on whether a quantity of association periods included in an association pattern period satisfies a threshold.

15. The network node of claim 12, wherein the PRACH mask index is associated with a masking pattern for determining the granularity of the PRACH mask index, wherein the masking pattern is associated with a first set of parameters or a second set of parameters based at least in part on whether the condition is satisfied.

16. The network node of claim 15, wherein the masking pattern is based at least in part on a reference period, wherein a type of the reference period is determined based at least in part on the first set of parameters or the second set of parameters.

17. The network node of claim 16, wherein the type of the reference period comprises an association period based at least in part on the masking pattern being associated with the first set of parameters, and wherein the type of the reference period comprises an association pattern period based at least in part on the masking pattern being associated with the second set of parameters.

18. The network node of claim 15, wherein the masking pattern comprises:
a first half of a quantity of a type of period in a given reference period,
a second half of the quantity of the type of period in the given reference period,
every period, of the type of period, in the given reference period that is associated with an even index number, or
every period, of the type of period, in the given reference period that is associated with an odd index number, wherein the type of period comprises an association period based at least in part on the masking pattern being associated with the first set of parameters, and wherein the type of period comprises an association pattern period based at least in part on the masking pattern being associated with the second set of parameters.

19. The network node of claim 15, wherein the first set of parameters is associated with masking association periods and the second set of parameters is associated with masking association pattern periods.

20. The network node of claim 12, wherein the condition comprises a first condition and a second condition, wherein the granularity of the PRACH mask index is determined to be an association period level granularity based at least in part on a satisfaction of the first condition, and wherein the granularity of the PRACH is determined to be an association pattern period level granularity based at least in part on a satisfaction of the second condition.
